(19) United States
(12) Patent Application Publication
(10) Pub. No.: US 2026/0261376 A1
(43) Pub. Date: Sep. 3, 2026

(54) SUB-BAND FULL DUPLEX FEATURE GROUPS

(71) Applicant: QUALCOMM Incorporated, San Diego, CA (US)

(72) Inventors: Muhammad Sayed Khairy ABDELGHAFFAR, San Jose, CA (US); Jae Ho RYU, San Diego, CA (US); Abdelrahman Mohamed IBRAHIM, San Diego, CA (US); Qian ZHANG, Basking Ridge, NJ (US)

(21) Appl. No.: 19/458,163

(22) Filed: Jan. 23, 2026

Related U.S. Application Data
(60) Provisional application No. 63/754,118, filed on Feb. 5, 2025.

(51) Int. Cl. H04L 5/00; H04B 7/06; H04L 5/14

(52) U.S. Cl. CPC H04L 5/0044; H04B 7/0626; H04L 5/0012; H04L 5/1438

(57) ABSTRACT

Various aspects of the present disclosure generally relate to wireless communication. In some aspects, a user equipment (UE) may transmit, to a network node, a first capability indication indicating support for a first group of primary sub-band full duplex (SBFD) operations including: transmitting SBFD uplink communications only within uplink sub-bands of SBFD symbols configured in downlink symbols or flexible symbols, receiving SBFD downlink communications only within downlink sub-bands of SBFD symbols configured in downlink symbols or flexible symbols, determining a link direction in accordance with one or more configured or scheduled communications and one or more collision handling rules, and applying a configuration for one or more power control parameters within a unified transmission configuration information state for the SBFD uplink communications in SBFD symbols. Numerous other aspects are described.

### CROSS-REFERENCE TO RELATED APPLICATION

This Patent Application claims priority to U.S. Provisional Patent Application No. 63/754,118, filed on February 5, 2025, entitled “SUB-BAND FULL DUPLEX FEATURE GROUPS,” and assigned to the assignee hereof. The disclosure of the prior Application is considered part of and is incorporated by reference into this Patent Application.

### FIELD OF THE DISCLOSURE

Aspects of the present disclosure generally relate to wireless communication and specifically relate to techniques, apparatuses, and methods associated with sub-band full duplex feature groups.

### DESCRIPTION OF THE RELATED TECHNOLOGY

Wireless communication systems are widely deployed to provide various services, which may involve carrying or supporting voice, text, other messaging, video, data, or other traffic. Typical wireless communication systems may employ multiple-access radio access technologies (RATs) capable of supporting communication among multiple wireless communication devices including user devices or other devices by sharing the available system resources (for example, time domain resources, frequency domain resources, spatial domain resources, or device transmit power, among other examples). Such multiple-access RATs are supported by technological advancements that have been adopted in various telecommunication standards, which define common protocols that enable different wireless communication devices to communicate on a local, municipal, national, regional, or global level. An example telecommunication standard is New Radio (NR). NR, which also may be referred to as 5G, is part of a continuous mobile broadband evolution promulgated by the Third Generation Partnership Project (3GPP). As the demand for connectivity continues to increase, further improvements in NR may be implemented, and other RATs, such as 6G and beyond, may be introduced to enable new applications and facilitate new use cases.

Some wireless networks permit sub-band full duplex (SBFD) communication. SBFD is a communication technique in which uplink and downlink transmissions occur simultaneously within distinct sub-bands of a shared frequency band. The sub-bands may be separated by frequency to mitigate interference between uplink and downlink transmissions.

### SUMMARY

Some aspects described herein relate to a user equipment (UE). The UE may include a processing system. The processing system may include one or more processors and one or more code-storing memories coupled with the one or more processors. The processing system may be configured to cause the UE to transmit, to a network node, a first capability indication indicating support for a first group of primary sub-band full duplex (SBFD) operations. The first group of primary SBFD operations includes two or more of: transmitting SBFD uplink communications only within uplink sub-bands of SBFD symbols configured in downlink symbols or flexible symbols, receiving SBFD downlink communications only within downlink sub-bands of SBFD symbols configured in downlink symbols or flexible symbols, determining a link direction in accordance with one or more configured or scheduled communications and one or more collision handling rules, applying a configuration for one or more power control parameters within a unified transmission configuration information (TCI) state for the SBFD uplink communications in SBFD symbols, configuring a maximum number of downlink-uplink switches per SBFD slot, configuring a maximum number of downlink-uplink switches per SBFD or time division duplexing period, configuring one or more sounding reference signal (SRS) sets, wherein each of the one or more SRS sets is associated with one of SBFD symbols or non-SBFD symbols, or configuring a contiguous or non-contiguous channel state information reference signal resource that overlaps one or more SBFD sub-band boundaries. The processing system may be configured to cause the UE to transmit the SBFD uplink communications in accordance with the first group of primary SBFD operations. The processing system may be configured to cause the UE to receive the SBFD downlink communications in accordance with the first group of primary SBFD operations.

Some aspects described herein relate to a network node. The network node may include a processing system. The processing system may include one or more processors and one or more code-storing memories coupled with the one or more processors. The processing system may be configured to cause the network node to receive a first capability indication indicating UE support for a first group of primary SBFD operations. The first group of primary SBFD operations supported by the UE includes two or more of: transmitting SBFD uplink communications only within uplink sub-bands of SBFD symbols configured in downlink symbols or flexible symbols, receiving SBFD downlink communications only within downlink sub-bands of SBFD symbols configured in downlink symbols or flexible symbols, determining a link direction in accordance with one or more configured or scheduled communications and one or more collision handling rules, applying a configuration for one or more power control parameters within a unified TCI state for the SBFD uplink communications in SBFD symbols, configuring a maximum number of downlink-uplink switches per SBFD slot, configuring a maximum number of downlink-uplink switches per SBFD or time division duplexing period, configuring one or more sounding reference signal (SRS) sets, wherein each of the one or more SRS sets is associated with one of SBFD symbols or non-SBFD symbols, or configuring a contiguous or non-contiguous channel state information reference signal resource that overlaps one or more SBFD sub-band boundaries. The processing system may be configured to cause the network node to receive the SBFD uplink communications in accordance with the first group of primary SBFD operations. The processing system may be configured to cause the network node to transmit the SBFD downlink communications in accordance with the first group of primary SBFD operations.

Some aspects described herein relate to a method of wireless communication at a UE. The method may include transmitting, to a network node, a first capability indication indicating support for a first group of primary SBFD operations. The first group of primary SBFD operations includes two or more of: transmitting SBFD uplink communications only within uplink sub-bands of SBFD symbols configured in downlink symbols or flexible symbols, receiving SBFD downlink communications only within downlink sub-bands of SBFD symbols configured in downlink symbols or flexible symbols, determining a link direction in accordance with one or more configured or scheduled communications and one or more collision handling rules, applying a configuration for one or more power control parameters within a unified TCI state for the SBFD uplink communications in SBFD symbols, configuring a maximum number of downlink-uplink switches per SBFD slot, configuring a maximum number of downlink-uplink switches per SBFD or time division duplexing period, configuring one or more sounding reference signal (SRS) sets, wherein each of the one or more SRS sets is associated with one of SBFD symbols or non-SBFD symbols, or configuring a contiguous or non-contiguous channel state information reference signal resource that overlaps one or more SBFD sub-band boundaries. The method may include transmitting the SBFD uplink communications in accordance with the first group of primary SBFD operations. The method may include receiving the SBFD downlink communications in accordance with the first group of primary SBFD operations.

Some aspects described herein relate to a method of wireless communication performed by a network node. The method may include receiving a first capability indication indicating UE support for a first group of primary SBFD operations. The first group of primary SBFD operations supported by the UE includes two or more of: transmitting SBFD uplink communications only within uplink sub-bands of SBFD symbols configured in downlink symbols or flexible symbols, receiving SBFD downlink communications only within downlink sub-bands of SBFD symbols configured in downlink symbols or flexible symbols, determining a link direction in accordance with one or more configured or scheduled communications and one or more collision handling rules, applying a configuration for one or more power control parameters within a unified TCI state for the SBFD uplink communications in SBFD symbols, configuring a maximum number of downlink-uplink switches per SBFD slot, configuring a maximum number of downlink-uplink switches per SBFD or time division duplexing period, configuring one or more sounding reference signal (SRS) sets, wherein each of the one or more SRS sets is associated with one of SBFD symbols or non-SBFD symbols, or configuring a contiguous or non-contiguous channel state information reference signal resource that overlaps one or more SBFD sub-band boundaries. The method may include receiving the SBFD uplink communications in accordance with the first group of primary SBFD operations. The method may include transmitting the SBFD downlink communications in accordance with the first group of primary SBFD operations.

Some aspects described herein relate to a non-transitory computer-readable medium that stores a set of instructions for wireless communication by a UE. The set of instructions, when executed by one or more processors of the UE, may cause the UE to transmit, to a network node, a first capability indication indicating support for a first group of primary SBFD operations. The first group of primary SBFD operations includes two or more of: transmitting SBFD uplink communications only within uplink sub-bands of SBFD symbols configured in downlink symbols or flexible symbols, receiving SBFD downlink communications only within downlink sub-bands of SBFD symbols configured in downlink symbols or flexible symbols, determining a link direction in accordance with one or more configured or scheduled communications and one or more collision handling rules, applying a configuration for one or more power control parameters within a unified TCI state for the SBFD uplink communications in SBFD symbols, configuring a maximum number of downlink-uplink switches per SBFD slot, configuring a maximum number of downlink-uplink switches per SBFD or time division duplexing period, configuring one or more sounding reference signal (SRS) sets, wherein each of the one or more SRS sets is associated with one of SBFD symbols or non-SBFD symbols, or configuring a contiguous or non-contiguous channel state information reference signal resource that overlaps one or more SBFD sub-band boundaries. The set of instructions, when executed by one or more processors of the UE, may cause the UE to transmit the SBFD uplink communications in accordance with the first group of primary SBFD operations. The set of instructions, when executed by one or more processors of the UE, may cause the UE to receive the SBFD downlink communications in accordance with the first group of primary SBFD operations.

Some aspects described herein relate to a non-transitory computer-readable medium that stores a set of instructions for wireless communication by a network node. The set of instructions, when executed by one or more processors of the network node, may cause the network node to receive a first capability indication indicating UE support for a first group of primary SBFD operations. The first group of primary SBFD operations supported by the UE includes two or more of: transmitting SBFD uplink communications only within uplink sub-bands of SBFD symbols configured in downlink symbols or flexible symbols, receiving SBFD downlink communications only within downlink sub-bands of SBFD symbols configured in downlink symbols or flexible symbols, determining a link direction in accordance with one or more configured or scheduled communications and one or more collision handling rules, applying a configuration for one or more power control parameters within a unified TCI state for the SBFD uplink communications in SBFD symbols, configuring a maximum number of downlink-uplink switches per SBFD slot, configuring a maximum number of downlink-uplink switches per SBFD or time division duplexing period, configuring one or more sounding reference signal (SRS) sets, wherein each of the one or more SRS sets is associated with one of SBFD symbols or non-SBFD symbols, or configuring a contiguous or non-contiguous channel state information reference signal resource that overlaps one or more SBFD sub-band boundaries. The set of instructions, when executed by one or more processors of the network node, may cause the network node to receive the SBFD uplink communications in accordance with the first group of primary SBFD operations. The set of instructions, when executed by one or more processors of the network node, may cause the network node to transmit the SBFD downlink communications in accordance with the first group of primary SBFD operations.

Some aspects described herein relate to an apparatus for wireless communication. The apparatus may include means for transmitting, to a network node, a first capability indication indicating support for a first group of primary SBFD operations. The first group of primary SBFD operations includes two or more of: transmitting SBFD uplink communications only within uplink sub-bands of SBFD symbols configured in downlink symbols or flexible symbols, receiving SBFD downlink communications only within downlink sub-bands of SBFD symbols configured in downlink symbols or flexible symbols, determining a link direction in accordance with one or more configured or scheduled communications and one or more collision handling rules, applying a configuration for one or more power control parameters within a unified TCI state for the SBFD uplink communications in SBFD symbols, configuring a maximum number of downlink-uplink switches per SBFD slot, configuring a maximum number of downlink-uplink switches per SBFD or time division duplexing period, configuring one or more sounding reference signal (SRS) sets, wherein each of the one or more SRS sets is associated with one of SBFD symbols or non-SBFD symbols, or configuring a contiguous or non-contiguous channel state information reference signal resource that overlaps one or more SBFD sub-band boundaries. The apparatus may include means for transmitting the SBFD uplink communications in accordance with the first group of primary SBFD operations. The apparatus may include means for receiving the SBFD downlink communications in accordance with the first group of primary SBFD operations.

Some aspects described herein relate to an apparatus for wireless communication. The apparatus may include means for receiving a first capability indication indicating UE support for a first group of primary SBFD operations. The first group of primary SBFD operations supported by the UE includes two or more of: transmitting SBFD uplink communications only within uplink sub-bands of SBFD symbols configured in downlink symbols or flexible symbols, receiving SBFD downlink communications only within downlink sub-bands of SBFD symbols configured in downlink symbols or flexible symbols, determining a link direction in accordance with one or more configured or scheduled communications and one or more collision handling rules, applying a configuration for one or more power control parameters within a unified TCI state for the SBFD uplink communications in SBFD symbols, configuring a maximum number of downlink-uplink switches per SBFD slot, configuring a maximum number of downlink-uplink switches per SBFD or time division duplexing period, configuring one or more sounding reference signal (SRS) sets, wherein each of the one or more SRS sets is associated with one of SBFD symbols or non-SBFD symbols, or configuring a contiguous or non-contiguous channel state information reference signal resource that overlaps one or more SBFD sub-band boundaries. The apparatus may include means for receiving the SBFD uplink communications in accordance with the first group of primary SBFD operations. The apparatus may include means for transmitting the SBFD downlink communications in accordance with the first group of primary SBFD operations.

The systems, methods, and devices of this disclosure each have several innovative aspects, no single one of which is solely responsible for the desirable attributes disclosed herein.

Aspects of the present disclosure may generally be implemented by or as a method, apparatus, system, computer program product, non-transitory computer-readable medium, user equipment, network node, wireless communication device, or processing system as substantially described in the Detailed Description with reference to, and as illustrated by, the accompanying drawings and appendix. Details of one or more implementations of the subject matter described in this disclosure are set forth in the accompanying drawings and appendix, and the description below. Other features, aspects, and advantages will become apparent from the description, the drawings, and the claims. Note that the relative dimensions of the following figures may not be drawn to scale.

### BRIEF DESCRIPTION OF THE DRAWINGS

FIG. 1 is a diagram illustrating an example of a wireless communication network.

FIG. 2 is a diagram illustrating an example disaggregated network node architecture.

FIG. 3 is a diagram illustrating an example sub-band full duplex (SBFD) communication in a wireless network.

FIG. 4 is a diagram illustrating an example associated with SBFD communication.

FIG. 5 is a diagram illustrating an example process performed at a user equipment (UE) or an apparatus of a UE.

FIG. 6 is a diagram illustrating an example process performed at a network node or an apparatus of a network node.

FIG. 7 is a diagram of an example apparatus for wireless communication.

FIG. 8 is a diagram of an example apparatus for wireless communication.

### DETAILED DESCRIPTION

A user equipment (UE) capable of sub-band full duplex (SBFD) communication may be configured with one or more SBFD symbols in addition to, or instead of, one or more downlink slots, uplink slots, or flexible slots associated with time division duplex (TDD) communication. An SBFD symbol may include communications via multiple sub-bands, and each of the multiple sub-bands may be associated with either uplink communications or downlink communications. A sub-band for uplink communications may be referred to as an uplink sub-band. A sub-band for downlink communications may be referred to as a downlink sub-band. An SBFD symbol may be configured with resources for communications on one or more downlink sub-bands, one or more uplink sub-bands, or both. The SBFD symbol may be configured with resources for downlink communications on two downlink sub-bands and a resource for uplink communications on one uplink sub-band. The two downlink sub-bands may be separated by the uplink sub-band. Additionally, in some aspects, each of the sub-bands may be separated by a guard band, which may be a range of frequencies between different sub-bands on which no communication is permitted.

Even if a UE can support SBFD communication, the UE may not be capable of supporting certain types of uplink communications, certain types of downlink communications, or both, in SBFD symbols. Accordingly, before engaging in SBFD communication with a network node, a UE may transmit, to the network node, one or more capability reports indicating the UE’s capabilities for SBFD communication. Transmitting individual capability reports for every possible SBFD capability can reduce network performance. In some aspects, every capability report transmitted by the UE increases network congestion while also delaying data communications between the UE and network node in SBFD symbols.

Various aspects relate generally to SBFD communications. Some aspects more specifically relate to UE support for SBFD communications. In some aspects, the UE may transmit one or more capability indications indicating support for different groups of SBFD operations. Each SBFD operation may be categorized as a primary SBFD operation or a supplemental SBFD operation, among other examples. The groups of SBFD operations may include a first group with only the primary SBFD operations. One or more additional groups (e.g., a second group or a third group) may each include only supplemental SBFD operations. The UE may transmit, to the network node, different capability reports that separately indicate UE support for an entire group (e.g., the first group) of SBFD operations rather than transmit individual capability reports for each SBFD operation within the group.

Particular aspects of the subject matter described in this disclosure can be implemented to realize one or more of the following potential advantages. In some examples, the described techniques can be used to reduce network congestion. In some aspects, by transmitting a capability indication that indicates UE support for multiple SBFD operations (e.g., all primary operations) the UE may transmit fewer capability reports to the network node. Additionally, the UE and network node may communicate using SBFD symbols sooner if the UE is able to communicate its capabilities with respect to SBFD operations with fewer transmissions to the network node.

5G New Radio (NR) may support enhanced mobile broadband (eMBB) access, Internet of Things (IoT) networks or reduced capability (RedCap) device deployments, ultra-reliable low-latency communication (URLLC) applications, or massive machine-type communication (mMTC), among other examples. To support these and other target verticals, a wireless communication system may be designed to implement a modularized functional infrastructure, a disaggregated and service-based network architecture, network function virtualization, network slicing, multi-access edge computing, millimeter wave (mmWave) technologies including massive multiple-input multiple-output (MIMO), beamforming, IoT device or RedCap device connectivity and management, industrial connectivity, licensed and unlicensed spectrum access, sidelink and other device-to-device direct communication (for example, cellular vehicle-to-everything (CV2X) communication), frequency spectrum expansion, overlapping spectrum use, small cell deployments, non-terrestrial network (NTN) deployments, device aggregation, advanced duplex communication (for example, sub-band full-duplex (SBFD)), multiple-subscriber implementations, high-precision positioning, radio frequency (RF) sensing, network energy savings (NES), low-power signaling and radios, or artificial intelligence or machine learning (AI/ML), among other examples.

The foregoing and other technological improvements may support use cases, such as wireless fronthauls, wireless midhauls, wireless backhauls, wireless data centers, extended reality (XR) and metaverse applications, meta services for supporting vehicle connectivity, holographic and mixed reality communication, autonomous and collaborative robots, vehicle platooning and cooperative maneuvering, sensing networks, gesture monitoring, human-brain interfacing, digital twin applications, asset management, and universal coverage applications using non-terrestrial or aerial platforms, among other examples.

The methods, operations, apparatuses, and techniques described herein may enable one or more of the foregoing technologies or new technologies or support one or more of the foregoing use cases or new use cases.

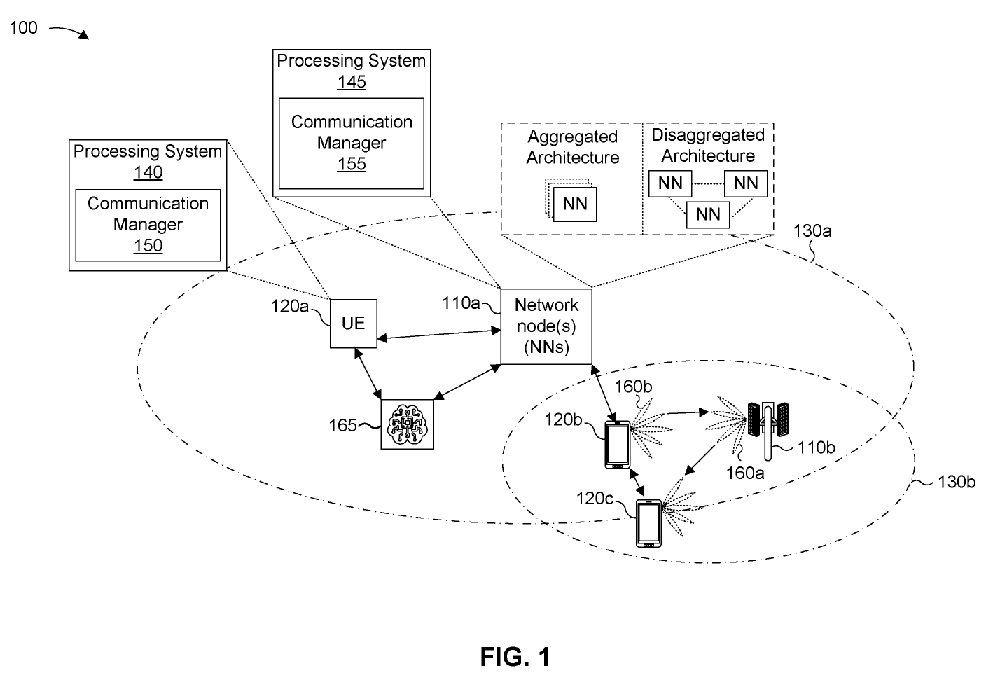

FIG. 1 is a diagram illustrating an example of a wireless communication network 100. The wireless communication network 100 may be or may include elements of a 5G network or a 6G network, among other examples. The wireless communication network 100 may include multiple network nodes 110. For example, in FIG. 1, the wireless communication network 100 includes multiple network nodes 110, including a network node 110a and a network node 110b (each of which also may be referred to herein simply as a “network node 110”). The network nodes 110 may support communications with multiple UEs 120. For example, in FIG. 1, the network nodes 110 support communication with a UE 120a, a UE 120b, and a UE 120c (each of which also may be referred to herein simply as a “UE 120”). In some examples, a UE 120 also may communicate with other UEs 120 and a network node 110 also may communicate with a core network and with other network nodes 110.

The network nodes 110 and the UEs 120 of the wireless communication network 100 communicate using the electromagnetic spectrum, which may be subdivided into various licensed or unlicensed operating bands, frequency ranges, component carriers, or channels that define associated frequencies available for communications. In some examples, each of the network nodes 110 and the UEs 120 may communicate using one or multiple component carriers in one or more operating bands or ranges. Typically, various operating bands are defined as frequency range designations FR1 (410 MHz through 7.125 GHz), FR2 (24.25 GHz through 52.6 GHz), FR3 (7.125 GHz through 24.25 GHz), FR4a or FR4-1 (52.6 GHz through 71 GHz), FR4 (52.6 GHz through 114.25 GHz), and FR5 (114.25 GHz through 300 GHz). Although a portion of FR1 is greater than 6 GHz, FR1 is often referred to (interchangeably) as a “sub-6 GHz” band in some documents and articles. Similarly, FR2 is often referred to (interchangeably) as a “millimeter wave” band in some documents and articles.

A network node 110 or a UE 120 may include one or more devices, components, or systems that enable communication with other devices, components, or systems of the wireless communication network 100. For example, a UE 120 and a network node 110 may each include one or more chips, system-on-chips (SoCs), chipsets, packages, or devices that individually or collectively constitute or comprise a processing system. As shown in FIG. 1, each UE 120 includes a processing system 140 and each network node 110 includes a processing system 145. A processing system (for example, the processing system 140 or the processing system 145) includes processor (or “processing”) circuitry in the form of one or multiple processors, microprocessors, processing units (such as central processing units (CPUs), graphics processing units (GPUs), neural processing units (NPUs) (also referred to as neural network processors or deep learning processors (DLPs)), or digital signal processors (DSPs)), processing blocks, application-specific integrated circuits (ASICs), programmable logic devices (PLDs), or other discrete gate or transistor logic or circuitry (any one or more of which may be generally referred to herein individually as a “processor” or collectively as “the processor” or “the processor circuitry”). Such processors may be individually or collectively configurable or configured to perform various functions or operations described herein. A group of processors collectively configurable or configured to perform a set of functions may include a first processor configurable or configured to perform a first function of the set and a second processor configurable or configured to perform a second function of the set. In some other examples, each of a group of processors may be configurable or configured to perform a same set of functions.

The processing system 140 and the processing system 145 may each include memory circuitry in the form of one or multiple memory devices, memory blocks, memory elements, or other discrete gate or transistor logic or circuitry, each of which may include or implement tangible storage media, such as random-access memory, or read-only memory, or combinations thereof (any one or more of which may be generally referred to herein individually as a “memory” or collectively as “the memory” or “the memory circuitry”). One or more of the memories may be coupled (for example, operatively coupled, communicatively coupled, electronically coupled, or electrically coupled) with one or more of the processors. One or more of the memories may individually or collectively store processor-executable code or instructions (such as software) (for example, which may referred to as “one or more code-storing memories” or “code-storing memory circuitry”). For example, “code-storing memory” or “code-storing memory circuitry” refers to memory (or memory circuitry) that is configured to store processor-executable code or instructions. The processor-executable code or instructions, when executed by one or more of the processors, may configure one or more of the processors (or processing circuitry) to perform various functions or operations described herein. Additionally, or alternatively, in some examples, one or more of the processors may be configured to perform various functions or operations described herein without requiring configuration by software. Software shall be construed broadly to mean instructions, instruction sets, code, code segments, program code, programs, subprograms, software modules, applications, software applications, software packages, routines, subroutines, objects, executables, threads of execution, procedures, or functions, among other examples, whether referred to as software, firmware, middleware, microcode, hardware description language, or otherwise.

The processing system 140 and the processing system 145 may each include or be coupled with one or more modems (such as a cellular (for example, a 5G or 6G compliant) modem). In some examples, one or more processors of the processing system 140 or the processing system 145 may include or implement one or more of the modems. The processing system 140 and the processing system 145 also may include or be coupled with multiple radios (collectively “the radio”), multiple RF chains, or multiple transceivers, each of which may in turn be coupled with one or more of multiple antennas. In some examples, one or more processors of the processing system 140 or the processing system 145 may include or implement one or more of the radios, RF chains, or transceivers. An RF chain may include one or more filters, mixers, oscillators, amplifiers, analog-to-digital converters (ADCs), or other devices that convert between an analog signal (such as for transmission or reception via an air interface) and a digital signal (such as for processing by the processing system 140 or by the processing system 145).

A network node 110 and a UE 120 may each include one or multiple antennas or antenna arrays. Typical network nodes 110 and UEs 120 may include multiple antennas, which may be organized or structured into one or more antenna panels, one or more antenna groups, one or more sets of antenna elements, or one or more antenna arrays, among other examples. As used herein, the term “antenna” can refer to one or more antennas, one or more antenna panels, one or more antenna groups, one or more sets of antenna elements, or one or more antenna arrays. The term “antenna panel” can refer to a group of antennas (such as antenna elements) arranged in an array or panel, which may facilitate beamforming by manipulating parameters associated with the group of antennas. The term “antenna module” may refer to circuitry including one or more antennas as well as one or more other components (such as filters, amplifiers, or processors) associated with integrating the antenna module into a wireless communication device, such as the network node 110 and the UE 120.

A network node 110 may be, may include, or also may be referred to as an NR network node, a 5G network node, a 6G network node, a Node B, a gNB, an access point (AP), a transmission reception point (TRP), a network entity, a network element, a network equipment, or another type of device, component, or system included in a radio access network (RAN). In various deployments, a network node 110 may be implemented as a single physical node (for example, a single physical structure) or may be implemented as two or more physical nodes (for example, two or more distinct physical structures). For example, a network node 110 may be a device or system that implements a part of a radio protocol stack, a device or system that implements a full radio protocol stack (such as a full gNB protocol stack), or a collection of devices or systems that collectively implement the full radio protocol stack. For example, and as shown, a network node 110 may be an aggregated network node having an aggregated architecture, meaning that the network node 110 may implement a full radio protocol stack that is physically and logically integrated within a single physical structure in the wireless communication network 100. For example, an aggregated network node 110 may include a single standalone base station or a single TRP that operates with a full radio protocol stack to enable or facilitate communication between a UE 120 and a core network of the wireless communication network 100.

Alternatively, and as also shown, a network node 110 may be a disaggregated network node 110 (sometimes referred to as a disaggregated base station), having a disaggregated architecture, meaning that the network node 110 may operate with a radio protocol stack that is physically distributed or logically distributed among two or more nodes in the same geographic location or in different geographic locations. In some deployments, disaggregated network nodes 110 may be used in an integrated access and backhaul (IAB) network, in an open radio access network (O-RAN) (such as a network configuration in compliance with the O-RAN Alliance), or in a virtualized radio access network (vRAN), also known as a cloud radio access network (C-RAN), to facilitate scaling by separating network functionality into multiple units or modules that can be individually deployed.

The disaggregated network nodes 110 of the wireless communication network 100 may include one or more central units (CUs), one or more distributed units (DUs), and one or more radio units (RUs). A CU may host one or more higher layers, such as a radio resource control (RRC) layer, a packet data convergence protocol (PDCP) layer, and a service data adaptation protocol (SDAP) layer, among other examples. A DU may host one or more of a radio link control (RLC) layer, a medium access control (MAC) layer, or one or more higher physical (PHY) layers depending, at least in part, on a functional split, such as a functional split defined by the 3GPP. In some examples, a DU also may host a lower PHY layer that is configured to perform functions, such as a fast Fourier transform (FFT), an inverse FFT (IFFT), beamforming, or physical random access channel (PRACH) extraction and filtering, among other examples. An RU may perform RF processing functions or lower PHY layer functions, such as an FFT, an IFFT, beamforming, or PRACH extraction and filtering, among other examples, according to a functional split, such as a lower layer split (LLS). In such an architecture, each RU can be operated to handle over the air (OTA) communication with one or more UEs 120. In some examples, a single network node 110 may include a combination of one or more CUs, one or more DUs, or one or more RUs. In some examples, a CU, a DU, or an RU may be implemented as a virtual unit, such as a virtual central unit (VCU), a virtual distributed unit (VDU), or a virtual radio unit (VRU), among other examples, which may be implemented as a virtual network function, such as in a cloud deployment.

In some examples, the wireless communication network 100 may be a heterogeneous network that includes network nodes 110 of various types. Different types of network nodes 110 may generally operate on the same or different operating bands, transmit at different power levels, or serve different coverage areas, each of which may be referred to as or associated with a particular cell 130 (for example, a cell 130a and a cell 130b).

The UEs 120 may be physically dispersed throughout the coverage area of the wireless communication network 100, and each UE 120 may be stationary or mobile. A UE 120 may be, may include, or also may be referred to as an access terminal, a mobile station, a client device, or a subscriber unit. A UE 120 may be, include, or be coupled with a cellular phone (for example, a smart phone), a personal digital assistant (PDA), a wireless modem, a wireless communication device, a handheld device, a laptop computer, a cordless phone, a wireless local loop (WLL) station, a tablet, a camera, a netbook, a smartbook, an ultrabook, a medical device, a biometric device, a wearable device (for example, a smart watch, smart clothing, smart glasses, a smart wristband, or smart jewelry), a gaming device, an entertainment device (for example, a music device, a video device, or a satellite radio), an XR device, a vehicular component or sensor, a smart meter or sensor, industrial manufacturing equipment, a Global Navigation Satellite System (GNSS) device (such as a Global Positioning System device or another type of positioning device), an artificially intelligent robot or other device implementing artificial intelligence, a UE function of a network node, or any other suitable device or function that may communicate in the wireless communication network 100.

Some UEs 120 may be classified according to different categories in association with different complexities or different capabilities. UEs 120 in a first category may be associated with relatively low complexity or cost such as NB-IoT devices or eMTC UEs. UEs 120 in a second category may include higher complexity or cost devices, such as mission-critical IoT devices, baseline UEs, high-tier UEs, advanced UEs, full-capability UEs, or premium UEs that are capable of URLLC, eMBB, or precise positioning in the wireless communication network 100. A third category of UEs 120 may have mid-tier complexity or capabilities (for example, capabilities between that of the UEs 120 of the first category and the UEs 120 of the second category). A UE 120 of the third category may be referred to as a reduced capability UE (“RedCap UE”), a mid-tier UE, an NR-Light UE, or an NR-Lite UE, among other examples.

In some examples, a network node 110 may be, may include, or may operate as an RU, a TRP, or a base station that communicates with one or more UEs 120 via a radio access link (which may be referred to as a “Uu” link). The radio access link may include a downlink and an uplink. “Downlink” (or “DL”) refers to a communication direction from a network node 110 to a UE 120, and “uplink” (or “UL”) refers to a communication direction from a UE 120 to a network node 110. Downlink and uplink resources may include time domain resources (for example, frames, subframes, slots, and symbols), frequency domain resources (for example, frequency bands, component carriers (CCs), subcarriers, resource blocks, and resource elements), and spatial domain resources (for example, particular transmit directions or beams).

Frequency domain resources may be subdivided into bandwidth parts (BWPs). A BWP may be a block of frequency domain resources (for example, a continuous set of resource blocks (RBs) within a full component carrier bandwidth) that may be configured at a UE-specific level. A UE 120 may be configured with both an uplink BWP and a downlink BWP (which may be the same or different). Each BWP may be associated with its own numerology (indicating a sub-carrier spacing (SCS) and cyclic prefix (CP)). A BWP may be dynamically configured or activated (for example, by a network node 110 transmitting a downlink control information (DCI) configuration to the one or more UEs 120) or reconfigured (for example, in real-time or near-real-time) according to changing network conditions in the wireless communication network 100 or specific requirements of one or more UEs 120. An active BWP defines the operating bandwidth of the UE 120 within the operating bandwidth of the serving cell.

As used herein, a downlink signal may be or include a reference signal, control information, or data. For example, downlink reference signals include a primary synchronization signal (PSS), a secondary SS (SSS), an SS block (SSB) (for example, that includes a PSS, an SSS, and a physical broadcast channel (PBCH)), a demodulation reference signal (DMRS), a phase tracking reference signal (PTRS), a tracking reference signal (TRS), and a channel state information (CSI) reference signal (CSI-RS), among other examples. A downlink signal carrying control information or data may be transmitted via a downlink channel. Downlink channels may include one or more control channels for transmitting control information and one or more data channels for transmitting data. Downlink reference signals may be transmitted in addition to, or multiplexed with, downlink control channel communications or downlink data channel communications. A downlink control channel may be specifically used to transmit DCI from a network node 110 to a UE 120. DCI generally contains the information the UE 120 needs to identify RBs in a subsequent subframe and how to decode them, including a modulation and coding scheme (MCS) or redundancy version parameters. Different DCI formats carry different information, such as scheduling information in the form of downlink or uplink grants, slot format indicators (SFIs), preemption indicators (PIs), transmit power control (TPC) commands, hybrid automatic repeat request (HARQ) information, new data indicators (NDIs), among other examples. A downlink data channel may be used to transmit downlink data (for example, user data associated with a UE 120) from a network node 110 to a UE 120. Downlink control channels may include physical downlink control channels (PDCCHs), and downlink data channels may include physical downlink shared channels (PDSCHs). Control information or data communications may be transmitted on a PDCCH and PDSCH, respectively. For example, a PDCCH can carry DCI, while a PDSCH can carry a MAC control element (MAC-CE), an RRC message, or user data, among other examples. Each PDSCH may carry one or more transport blocks (TBs) of data.

As used herein, an uplink signal may include a reference signal, control information, or data. For example, uplink reference signals include a sounding reference signal (SRS), a PTRS, and a DMRS, among other examples. An uplink signal carrying control information or data may be transmitted via an uplink channel. An uplink channel may include one or more control channels for transmitting control information and one or more data channels for transmitting data. Uplink reference signals may be transmitted in addition to, or multiplexed with, uplink control channel communications or uplink data channel communications. An uplink control channel may be specifically used to transmit uplink control information (UCI) from a UE 120 to a network node 110. An uplink data channel may be used to transmit uplink data (for example, user data associated with a UE 120) from a UE 120 to a network node 110. Uplink control channels may include physical uplink control channels (PUCCHs), and uplink data channels may include physical uplink shared channels (PUSCHs). Control information or data communications may be transmitted on a PUCCH and PUSCH, respectively. For example, a PUCCH can carry UCI, while a PUSCH can carry a MAC-CE, an RRC message, or user data, among other examples. UCI can include a scheduling request (SR), HARQ feedback information (for example, a HARQ acknowledgement (ACK) indication or a HARQ negative acknowledgement (NACK) indication), uplink power control information (for example, an uplink TPC parameter), or CSI, among other examples. CSI can include a channel quality indicator (CQI) (indicative of downlink channel conditions to facilitate selection of transmission parameters, such as an MCS, by a network node 110), a precoding matrix indicator (PMI), a CSI-RS resource indicator (CRI) (for example, indicative of a beam used to transmit a CSI-RS), an SS/PBCH resource block indicator (SSBRI) (for example, indicative of a beam used to transmit an SSB), a layer indicator (LI), a rank indicator (RI), or measurement information (for example, a layer 1 (L1)- reference signal received power (RSRP) parameter, a received signal strength indicator (RSSI) parameter, a reference signal received quality (RSRQ) parameter, among other examples) which can be used for beam management, among other examples. Each PUSCH may carry one or more TBs of data.

The information (for example, data, control information, or reference signal information) transmitted by a network node 110 to a UE 120, or vice versa, may be represented as a sequence of binary bits that are mapped (for example, modulated) to an analog signal waveform (for example, a discrete Fourier transform (DFT)-spread-orthogonal frequency division multiplexing (OFDM) (DFT-s-OFDM) waveform or a CP-OFDM waveform) that is transmitted by the network node 110 or UE 120 over a wireless communication channel. In some examples, the network node 110 or the UE 120 (for example, using the processing system 145 or the processing system 140, respectively) may select an MCS (for example, an order of quadrature amplitude modulation (QAM), such as 64-QAM, 128-QAM, or 256-QAM, among other examples) for a downlink signal or an uplink signal. For example, the network node 110 may select an MCS for a downlink signal in accordance with UCI received from the UE 120 or may transmit, to the UE 120, an indication of an MCS to be applied for an uplink signal.

A network node 110 or a UE 120 (such as by using the processing system 145 or the processing system 140, respectively, or one or more coupled modems) may perform signal processing on the information (such as filtering, amplification, modulation, digital-to-analog conversion, an IFFT operation, multiplexing, interleaving, mapping, or encoding, among other examples) to generate a processed signal in accordance with the selected MCS. In some examples, the network node 110 or the UE 120 (for example, using the processing system 145 or the processing system 140, respectively, or one or more coupled encoders or modems) may perform a channel coding operation or a forward error correction (FEC) operation to control errors in transmitted information. For example, the network node 110 or the UE 120 may perform an encoding operation to generate encoded information (such as by selectively introducing redundancy into the information, typically using an error correction code (ECC), such as a polar code or a low-density parity-check (LDPC) code). The network node 110 or the UE 120 (for example, using the processing system 145 or one or more modems) may further perform spatial processing (for example, precoding) on the encoded information to generate one or more processed or precoded signals for downlink or uplink transmission, respectively. In some examples, the network node 110a or the UE 120a may perform codebook-based precoding or non-codebook-based precoding. Codebook-based precoding may involve selecting a precoder (for example, a precoding matrix) using a codebook. For example, the network node 110a may provide precoding information indicating which precoder, defined by the codebook, is to be used by the UE 120a. Non-codebook-based precoding may involve selecting or deriving a precoder based on, or otherwise associated with, one or more downlink or uplink signal measurements. The network node 110a or the UE 120a may transmit the processed downlink or uplink signals, respectively, via one or more antennas.

The network node 110a or the UE 120a may receive uplink signals or downlink signals, respectively, via one or more antennas. The network node 110a or the UE 120a (for example, using the processing system 145 or the processing system 140, respectively, or one or more coupled modems) may perform signal processing (for example, in accordance with the MCS) on the received uplink or downlink signals, respectively (such as filtering, amplification, demodulation, analog-to-digital conversion, an FFT operation, demultiplexing, deinterleaving, de-mapping, equalization, interference cancellation, or decoding, among other examples), to map the received signal(s) to a sequence of binary bits (for example, received information) that estimates the information transmitted by the network node 110 or the UE 120 via the downlink or uplink signals. The network node 110a or the UE 120a (for example, using the processing system 145 or the processing system 140, respectively, or a coupled decoder or one or more modems) may decode the received information (such as by using an ECC, a decoding operation, or an FEC operation) to detect errors or correct bit errors in the received information to generate decoded information. The decoded information may estimate the information transmitted via the downlink or uplink signals.

In some examples, a UE 120 and a network node 110 may perform MIMO communication. MIMO communication generally refers to transmitting or receiving multiple signals (such as multiple layers or multiple data streams) simultaneously over the same time and frequency resources. A network node 110 or a UE 120 may communicate using single-user MIMO or multi-user MIMO (MU-MIMO), the latter of which being used by a network node 110 to simultaneously transmit signals to multiple UEs 120. MIMO techniques may involve spatial multiplexing (multi-layer transmission) or beamforming. To implement beamforming, the amplitudes or phases of signals transmitted via antenna elements may be modulated and shifted relative to each other (such as by manipulating a phase shift, a phase offset, or an amplitude) to generate one or more beams. For example, a network node 110 may generate one or more beams 160a, and a UE 120 may generate one or more beams 160b. The term “beam” may refer to a directional transmission of a wireless signal toward a receiving device or otherwise in a desired direction, a directional reception of a wireless signal from a transmitting device or otherwise in a desired direction, a direction associated with such a directional transmission or directional reception, a set of directional resources associated with a signal transmission or signal reception (for example, an angle of arrival, a horizontal direction, or a vertical direction), or a set of parameters or resources associated with one or more aspects of a directional signal, among other examples. In some examples, a network node 110 or a UE 120 may implement massive MIMO, which may be associated with an increased (for example, “massive”) quantity of antennas at the network node 110 or at the UE 120, such as in a network implementing mmWave technology, which enables more precise beamforming or reduced interference. In some examples, the wireless communication network 100 may implement multi-TRP (mTRP) operation (including redundant transmission or reception on multiple TRPs) or non-coherent joint transmission (NC-JT).

The network node 110 and the UE 120 may establish a communication link or beam pair, and otherwise increase reliability, throughput, signal strength, or other signal properties for MIMO communications, by performing beam management operations, such as an initial beam acquisition operation, a beam refinement operation, or a beam recovery operation. For example, an initial beam acquisition operation may involve the network node 110 transmitting signals (for example, SSBs or other signals) via respective beams (for example, of the beams 160 of the network node 110) and the UE 120 receiving and measuring the signal(s) via respective beams of multiple beams (for example, from the beams 160 of the UE 120) to identify a best beam (or beam pair) for communication between the UE 120 and the network node 110. A beam refinement operation may involve a first device (for example, the UE 120 or the network node 110) transmitting signal(s) via a subset of beams (for example, identified based on, or otherwise associated with, measurements reported as part of one or more other beam management operations). A second device (for example, the network node 110 or the UE 120) may receive the signal(s) via a single beam (for example, to identify the best beam for communication from the subset of beams). The beam(s) may be identified or defined via one or more spatial parameters, such as a transmission configuration indicator (TCI) state or a quasi co-location (QCL) parameter, among other examples.

Some aspects and techniques as described herein may be implemented, at least in part, using an artificial intelligence (AI) program (for example, referred to herein as an “AI/ML model”), such as a program that includes a machine learning (ML) model or an artificial neural network (ANN) model. The AI/ML model may be deployed at one or more devices 165 (for example, one or more network nodes 110, one or more UEs 120, one or more servers, or one or more components of a cloud computing network, among other examples). For example, in a deployment in which AI/ML functionality is performed independently at a device 165, sometimes referred to as “overlay AI/ML,” the AI/ML model (or an instance or portion of the AI/ML model) may be deployed at a UE 120 (for example, by the processing system 140), a network node 110 (for example, by the processing system 145), one or more servers, or one or more components of a cloud computing network, among other examples. Additionally, or alternatively, in a deployment where AI/ML functionality is coordinated between different devices 165, sometimes referred to as “coordinated AI/ML,” or performed at all device and network layers, sometimes referred to as “native AI/ML,” the AI/ML model (or an instance of the AI/ML model) may be deployed at multiple devices 165 (for example, a first portion of the AI/ML model may be deployed at a UE 120 and a second portion of the AI/ML model may be deployed at a network node 110). In other examples of coordinated AI/ML or native AI/ML, a first AI/ML model may be deployed at a UE 120 and a second AI/ML model may be deployed at a network node 110. The AI/ML model(s) may be configured to enhance various aspects of the wireless communication network 100 (for example, to increase privacy, reliability, or efficient use of network bandwidth, or to reduce latency, among other examples). For example, the AI/ML model(s) may be trained to identify patterns or relationships in data corresponding to the wireless communication network 100, a device, or an air interface, among other examples. The AI/ML model(s) may support operational decisions relating to one or more aspects associated with wireless communications devices, networks, or services.

Accordingly, in some examples, the AI/ML model(s) may enable AI-as-a-Service (for example, an end-to-end AI/ML service via a user plane) for use cases, such as a self-organizing network (SON), minimization of drive test (MDT), quality of experience (QoE), positioning, sensing, predictive mobility, or traffic prediction, among other examples. In some examples, AI-as-a-Service use cases may include measurement collection reporting by a UE 120, device selection criteria (for example, according to a geographical area where measurements are to be collected or UE capabilities to be used to collected measurements), or reporting configurations (for example, reporting parameters such as location, time, or sensor information, among other examples). Additionally, or alternatively, the AI/ML model(s) may enable AI/ML procedures (for example, RAN-triggered service establishment, configuration, inferencing using UE-side or network-side models, performance monitoring or management, or capability signaling, among other examples). Additionally, or alternatively, the AI/ML model(s) may enable RAN-based AI/ML services via one or more application program interfaces (APIs) or management interfaces for use cases, such as beam management, radio resource monitoring (RRM) relaxation, mobility prediction, load prediction, network energy savings, or coverage and capacity improvements, among other examples.

In some aspects, the UE 120 may include a communication manager 150. As described in more detail elsewhere herein, the communication manager 150 may transmit, to a network node, a first capability indication indicating support for a first group of primary SBFD operations. The first group of primary SBFD operations may include: transmitting SBFD uplink communications only within uplink sub-bands of SBFD symbols configured in downlink symbols or flexible symbols, receiving SBFD downlink communications only within downlink sub-bands of SBFD symbols configured in downlink symbols or flexible symbols, determining a link direction in accordance with one or more configured or scheduled communications and one or more collision handling rules, and applying a configuration for one or more power control parameters within a unified TCI state for the SBFD uplink communications in SBFD symbols. The communication manager 150 may transmit the SBFD uplink communications in accordance with the first group of primary SBFD operations; and receive the SBFD downlink communications in accordance with the first group of primary SBFD operations. Additionally, or alternatively, the communication manager 150 may perform one or more other operations described herein.

In some aspects, the network node 110 may include a communication manager 155. As described in more detail elsewhere herein, the communication manager 155 may receive a first capability indication indicating UE support for a first group of primary SBFD operations. The first group of primary SBFD operations supported by the UE may include the UE: transmitting SBFD uplink communications only within uplink sub-bands of SBFD symbols configured in downlink symbols or flexible symbols, receiving SBFD downlink communications only within downlink sub-bands of SBFD symbols configured in downlink symbols or flexible symbols, determining a link direction in accordance with one or more configured or scheduled communications and one or more collision handling rules, and applying a configuration for one or more power control parameters within a unified TCI state for the SBFD uplink communications in SBFD symbols. The communication manager 155 may receive the SBFD uplink communications in accordance with the first group of primary SBFD operations; and transmit the SBFD downlink communications in accordance with the first group of primary SBFD operations. Additionally, or alternatively, the communication manager 155 may perform one or more other operations described herein.

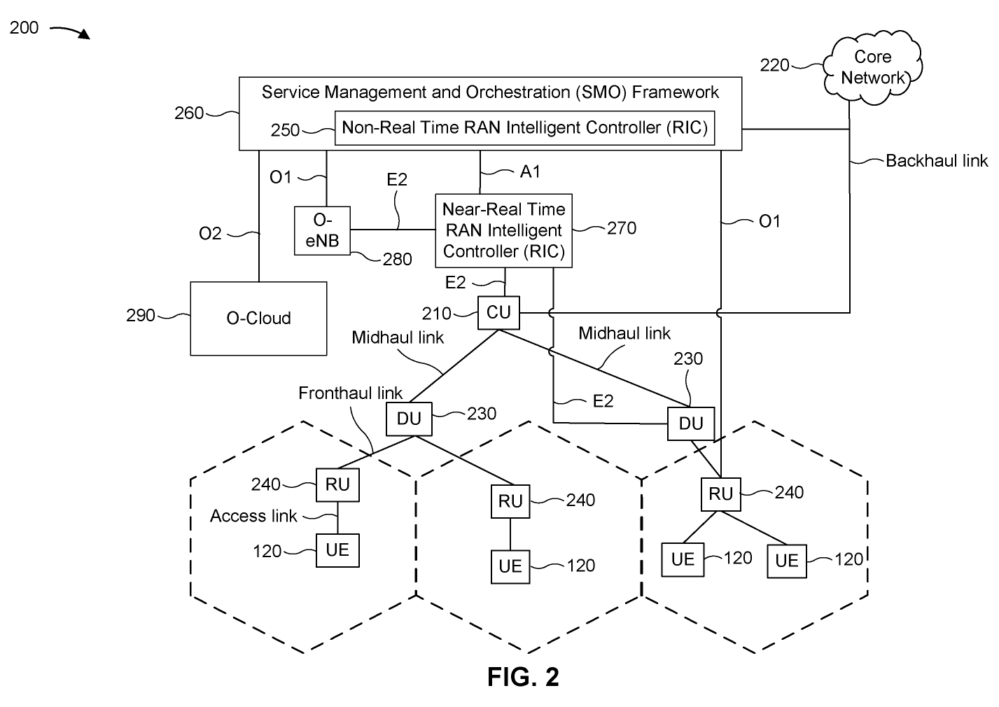

FIG. 2 is a diagram illustrating an example disaggregated network node architecture 200. One or more components of the example disaggregated network node architecture 200 may be, may include, or may be included in one or more network nodes (such one or more network nodes 110). The disaggregated network node architecture 200 may include a CU 210 that can communicate directly with a core network 220 via a backhaul link, or that can communicate indirectly with the core network 220 via one or more disaggregated control units, such as a non-real-time (Non-RT) RAN intelligent controller (RIC) 250 associated with a Service Management and Orchestration (SMO) Framework 260 or a near-real-time (Near-RT) RIC 270 (for example, via an E2 link). The CU 210 may communicate with one or more DUs 230 via respective midhaul links, such as via F1 interfaces. Each of the DUs 230 may communicate with one or more RUs 240 via respective fronthaul links. Each of the RUs 240 may communicate with one or more UEs 120 via respective RF access links. In some deployments, a UE 120 may be simultaneously served by multiple RUs 240.

Each of the components of the disaggregated network node architecture 200, including the CUs 210, the DUs 230, the RUs 240, the Near-RT RICs 270, the Non-RT RICs 250, and the SMO Framework 260, may include one or more interfaces or may be coupled with one or more interfaces for transmitting or receiving signals, such as data, control information, or reference signals via a wired or wireless transmission medium.

In some aspects, the CU 210 may be logically split into one or more CU user plane (CU-UP) units and one or more CU control plane (CU-CP) units. A CU-UP unit may communicate bidirectionally with a CU-CP unit via an interface, such as the E1 interface when implemented in an O-RAN configuration. The CU 210 may be deployed to communicate with one or more DUs 230, as necessary, for network control and signaling. Each DU 230 may correspond to a logical unit that includes one or more base station functions to control the operation of one or more RUs 240. For example, a DU 230 may host various layers, such as an RLC layer, a MAC layer, or one or more PHY layers, such as one or more high PHY layers or one or more low PHY layers. Each layer (which also may be referred to as a module) may be implemented with an interface for communicating signals with other layers (and modules) hosted by the DU 230, or for communicating signals with the control functions hosted by the CU 210. Each RU 240 may implement lower layer functionality. In some aspects, real-time and non-real-time aspects of control and user plane communication with the RU(s) 240 may be controlled by the corresponding DU 230.

The SMO Framework 260 may support RAN deployment and provisioning of non-virtualized and virtualized network elements. For non-virtualized network elements, the SMO Framework 260 may support the deployment of dedicated physical resources for RAN coverage requirements, which may be managed via an operations and maintenance interface, such as an O1 interface. For virtualized network elements, the SMO Framework 260 may interact with a cloud computing platform (such as an open cloud (O-Cloud) platform 290) to perform network element life cycle management (such as to instantiate virtualized network elements) via a cloud computing platform interface, such as an O2 interface. A virtualized network element may include, but is not limited to, a CU 210, a DU 230, an RU 240, a non-RT RIC 250, or a Near-RT RIC 270. In some aspects, the SMO Framework 260 may communicate with a hardware aspect of a 4G RAN, a 5G NR RAN, or a 6G RAN, such as an open eNB (O-eNB) 280, via an O1 interface. Additionally, or alternatively, the SMO Framework 260 may communicate directly with each of one or more RUs 240 via a respective O1 interface. In some deployments, this configuration can enable each DU 230 and the CU 210 to be implemented in a cloud-based RAN architecture, such as a vRAN architecture.

The Non-RT RIC 250 may include or may implement a logical function that enables non-real-time control and optimization of RAN elements and resources, AI/ML workflows including model training and updates, or policy-based guidance of applications or features in the Near-RT RIC 270. The Non-RT RIC 250 may be coupled to or may communicate with (such as via an A1 interface) the Near-RT RIC 270. The Near-RT RIC 270 may include or may implement a logical function that enables near- real-time control and optimization of RAN elements and resources via data collection and actions via an interface (such as via an E2 interface) connecting one or more CUs 210, one or more DUs 230, or an O-eNB 280 with the Near-RT RIC 270.

In some aspects, to generate AI/ML models to be deployed in the Near-RT RIC 270, the Non-RT RIC 250 may receive parameters or external enrichment information from external servers. Such information may be utilized by the Near-RT RIC 270 and may be received at the SMO Framework 260 or the Non-RT RIC 250 from non-network data sources or from network functions. In some examples, the Non-RT RIC 250 or the Near-RT RIC 270 may tune RAN behavior or performance. For example, the Non-RT RIC 250 may monitor long-term trends and patterns for performance and may employ AI/ML models to perform corrective actions via the SMO Framework 260 (such as reconfiguration via an O1 interface) or via creation of RAN management policies (such as A1 interface policies).

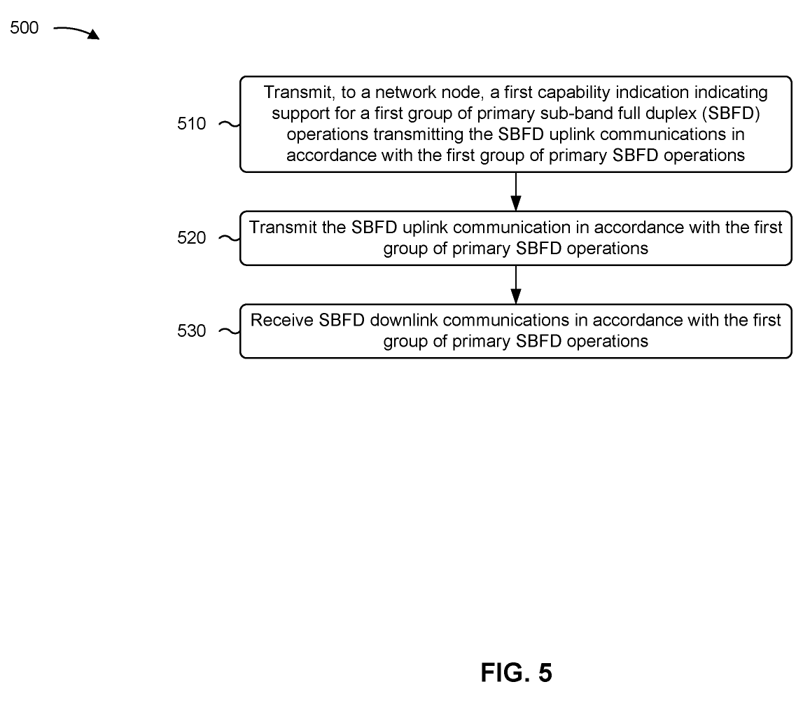

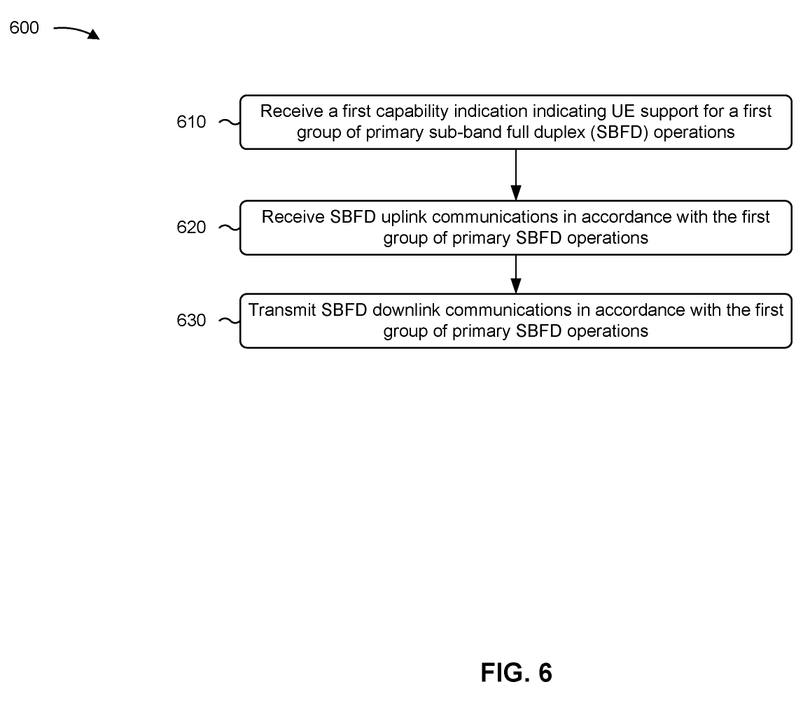

The network node 110, the processing system 145 of the network node 110, the UE 120, the processing system 140 of the UE 120, the CU 210, the DU 230, the RU 240, or any other component(s) of FIG. 1 or FIG. 2 may implement one or more techniques or perform one or more operations associated with communication in accordance with SBFD feature groups, as described in more detail elsewhere herein. For example, the processing system 145 of the network node 110, the processing system 140 of the UE 120, the CU 210, the DU 230, or the RU 240 may perform or direct operations of, for example, process 500 of FIG. 5, process 600 of FIG. 6, or other processes as described herein (alone or in conjunction with one or more other processors). Memory of the network node 110 may store data and program code (or instructions) for the network node 110, the CU 210, the DU 230, or the RU 240. In some examples, the memory of the network node 110 may store data relating to a UE 120, such as RRC state information or a UE context. Memory of a UE 120 may store data and program code (or instructions) for the UE 120, such as context information. In some examples, the memory of the UE 120 or the memory of the network node 110 may include a non-transitory computer-readable medium storing a set of instructions for wireless communication. For example, the set of instructions, when executed by one or more processors (for example, of the processing system 145 or the processing system 140) of the network node 110, the UE 120, the CU 210, the DU 230, or the RU 240, may cause the one or more processors to perform process 500 of FIG. 5, process 600 of FIG. 6, or other processes as described herein. In some examples, executing instructions may include running the instructions, converting the instructions, compiling the instructions, or interpreting the instructions, among other examples.

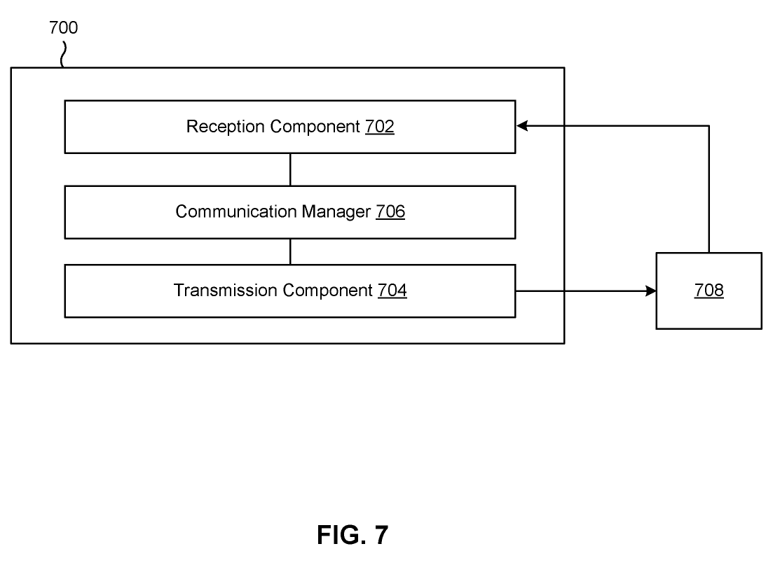

In some aspects, the UE 120 includes means for transmitting, to a network node 110, a first capability indication indicating support for a first group of primary SBFD operations; means for transmitting the SBFD uplink communications in accordance with the first group of primary SBFD operations; or means for receiving the SBFD downlink communications in accordance with the first group of primary SBFD operations. The first group of primary SBFD operations may include: transmitting SBFD uplink communications only within uplink sub-bands of SBFD symbols configured in downlink symbols or flexible symbols, receiving SBFD downlink communications only within downlink sub-bands of SBFD symbols configured in downlink symbols or flexible symbols, determining a link direction in accordance with one or more configured or scheduled communications and one or more collision handling rules, applying a configuration for one or more power control parameters within a unified TCI state for the SBFD uplink communications in SBFD symbols, configuring a maximum number of downlink-uplink switches per SBFD slot, configuring a maximum number of downlink-uplink switches per SBFD or time division duplexing period, configuring one or more sounding reference signal (SRS) sets, wherein each of the one or more SRS sets is associated with one of SBFD symbols or non-SBFD symbols, or configuring a contiguous or non-contiguous channel state information reference signal resource that overlaps one or more SBFD sub-band boundaries. The means for the UE 120 to perform operations described herein may include, for example, one or more of communication manager 150, processing system 140, a radio, one or more RF chains, one or more transceivers, one or more antennas, one or more modems, a reception component (for example, reception component 702 depicted and described in connection with FIG. 7), or a transmission component (for example, transmission component 704 depicted and described in connection with FIG. 7), among other examples.

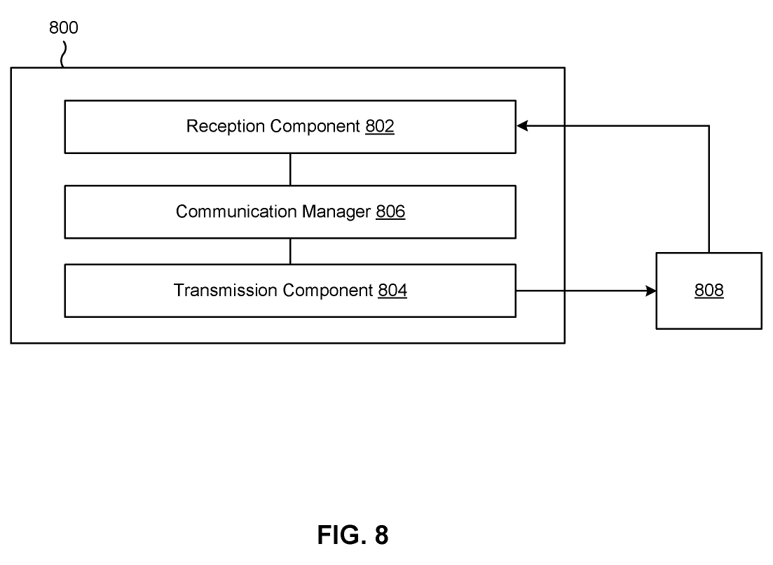

In some aspects, the network node includes means for receiving a first capability indication indicating UE support for a first group of primary SBFD operations; means for receiving the SBFD uplink communications in accordance with the first group of primary SBFD operations; or means for transmitting the SBFD downlink communications in accordance with the first group of primary SBFD operations. The first group of primary SBFD operations supported by the UE includes two or more of: transmitting SBFD uplink communications only within uplink sub-bands of SBFD symbols configured in downlink symbols or flexible symbols, receiving SBFD downlink communications only within downlink sub-bands of SBFD symbols configured in downlink symbols or flexible symbols, determining a link direction in accordance with one or more configured or scheduled communications and one or more collision handling rules, applying a configuration for one or more power control parameters within a unified TCI state for the SBFD uplink communications in SBFD symbols, configuring a maximum number of downlink-uplink switches per SBFD slot, configuring a maximum number of downlink-uplink switches per SBFD or time division duplexing period, configuring one or more sounding reference signal (SRS) sets, wherein each of the one or more SRS sets is associated with one of SBFD symbols or non-SBFD symbols, or configuring a contiguous or non-contiguous channel state information reference signal resource that overlaps one or more SBFD sub-band boundaries. The means for the network node to perform operations described herein may include, for example, one or more of communication manager 155, processing system 145, a radio, one or more RF chains, one or more transceivers, one or more antennas, one or more modems, a reception component (for example, reception component 802 depicted and described in connection with FIG. 8), or a transmission component (for example, transmission component 804 depicted and described in connection with FIG. 8), among other examples.

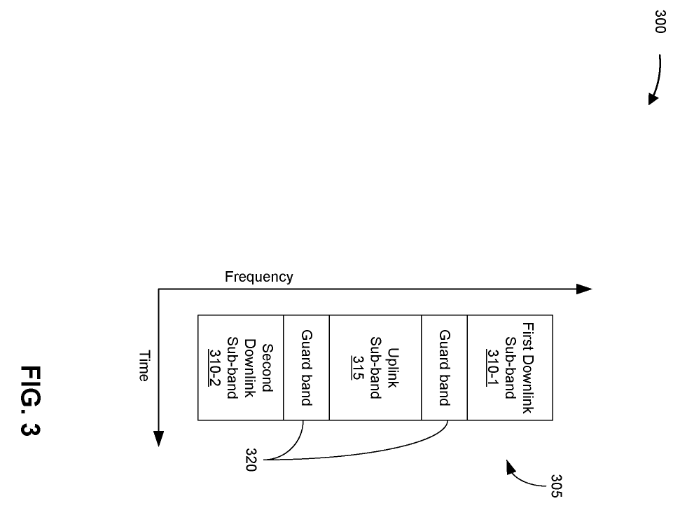

FIG. 3 is a diagram illustrating an example 300 SBFD communication in a wireless network. In SBFD, a UE (e.g., UE 120) may transmit an uplink communication to a network node (e.g., network node 110) and receive a downlink communication from the network node at the same time, but on different frequency resources. For example, the different frequency resources may be sub-bands of a frequency band, such as a TDD band.

In some aspects, an SBFD symbol 305 may include resources for a first downlink sub-band 310-1, a second downlink sub-band 310-2, and an uplink sub-band 315. While overlapping in time, the first downlink sub-band 310-1, the second downlink sub-band 310-2, and the uplink sub-band 315 may be associated with resources using different frequency ranges in the SBFD symbol 305. In some aspects, each downlink sub-band 310 may be separated from the uplink sub-band 315 by a guard band 320.

As described in greater detail below, the UE may be configured to transmit one or more capability reports to the network node. The one or more capability reports may indicate UE support for one or more SBFD operations. In some aspects, at least one of the capability reports may indicate UE support for a group of SBFD operations. In some aspects, SBFD operations may be categorized as primary SBFD operations or supplemental SBFD operations. The primary SBFD operations may be operations or parameters that are implicitly indicated via the presence of one or more bits in a bit field indicating support for SBFD operations. Alternatively, in some aspects, the primary SBFD operations include operations or parameters necessary for SBFD operation. Accordingly, support for the primary SBFD operations may be indicated by a capability report indicating support for the one or more operations or parameters necessary for SBFD communication. One capability report may indicate UE support for at least the group of primary SBFD operations. The group of primary SBFD operations supported by the UE may include transmitting SBFD uplink communications only within uplink sub-bands of SBFD symbols configured in downlink symbols or flexible symbols, receiving SBFD downlink communications only within downlink sub-bands of SBFD symbols configured in downlink symbols or flexible symbols, determining a link direction in accordance with one or more configured or scheduled communications and one or more collision handling rules, and applying a configuration for one or more power control parameters within a unified TCI state for the SBFD uplink communications in SBFD symbols.

One or more additional capability reports may indicate UE support for at least one supplemental SBFD operation. The supplemental SBFD operation may include applying a configuration for one or more partial resource block groups for a PDSCH or a PUSCH using frequency domain resource allocation type 0. For such an operation and also in some other aspects, the supplemental SBFD operation may include mapping a DMRS sequence to one or more assigned physical resource blocks within one or more downlink sub-bands 310 or one or more uplink sub-bands 315 in one or more physical resource blocks.

In some aspects, the supplemental SBFD operation may include rate matching a PDSCH for frequency domain resource allocation type 1 narrow-band precoding resource block groups. In some aspects, one or more PDSCH resources may be mapped to an assigned physical resource block within a downlink sub-band, and the supplemental SBFD operation may include determining a transport block size in accordance with one or more valid physical resource blocks (PRBs) within one or more downlink sub-bands 310 or within an uplink sub-band 315 and in accordance with a mapping of one or more DMRSs of SBFD symbols 305 to the one or more valid PRBs. In some aspects, the supplemental SBFD operation may include applying a frequency hopping offset in accordance with a frequency hopping offset list for SBFD uplink PUSCH communications in SBFD symbols 305. In some aspects, the supplemental SBFD operation may the UE applying a configuration for one or more frequency hopping resources for SBFD uplink PUCCH communications. The one or more frequency hopping resources may include one or more of a first frequency hop resource block and a second frequency hop resource block for each PUCCH resource. In some aspects, the supplemental SBFD operation may include the UE applying a configuration for a specific number (e.g., one or two) of downlink sub-bands 310 for downlink scheduling in SBFD symbols. In some aspects, the supplemental SBFD operation may include the UE applying a configuration for a minimum guard band 320 between the uplink sub-band 315 and each of the downlink sub-bands 310. In some aspects, the supplemental SBFD operation may include the UE applying a configuration for a maximum number of downlink-uplink switches per SBFD slot. The downlink-uplink switch may include switches between an uplink sub-band 315 and a downlink sub-band 310 within the SBFD symbol 305. Alternatively, configuring the maximum number of downlink-uplink switches, per SBFD symbol, per slot, or per TDD period, may be a primary SBFD operation. The example 300 of FIG. 3 shows two downlink-uplink switches (e.g., a first switch from the first downlink sub-band 310-1 to the uplink sub-band 315 and a second switch from the uplink sub-band 315 to the second downlink sub-band 310-2). In some aspects, the supplemental SBFD operation may include the UE applying a configuration for a maximum number of downlink-uplink switches per SBFD symbol 305 or TDD period. In some aspects, the supplemental SBFD operation may include uplink transmission or downlink reception across different slots, and each slot may be configured with one of only SBFD symbols 305 or only non-SBFD symbols. In some aspects, the supplemental SBFD operation may include the UE applying an SBFD-specific configuration for one or more SRS sets. Alternatively, configuring the one or more SRS sets for SBFD may be a primary SBFD operation. In the SBFD-specific configuration, each of the SRS sets may be associated with one of SBFD symbols 305 or non-SBFD symbols. In some aspects, the supplemental SBFD operation may include transmitting a partial CSI sub-band report. In some aspects, the supplemental SBFD operation may include applying a configuration for a contiguous CSI-RS resource that overlaps one or more SBFD sub-band boundaries (e.g., boundaries between adjacent SBFD symbols 305). In some aspects, the contiguous CSI-RS resource may be associated with a downlink PRB. In some aspects, the supplemental SBFD operation may include the UE applying a configuration for a non-contiguous CSI-RS resource in two or more downlink sub-bands (e.g., the first downlink sub-band 310-1 and the second downlink sub-band 310-2). In some aspects, the supplemental SBFD operation may include reporting a capability associated with a CSI processing timeline. Alternatively, configuring the contiguous or non-contiguous CSI-RS resource may be a primary SBFD operation.

In some aspects, the supplemental SBFD operation may be associated with a PRACH transmission. In some aspects, the UE 120 may be configured to transmit, to the network node 110, the second capability indication to indicate UE support for a PRACH transmission with preamble repetition in a set of random access occasions. In some aspects, there may be separate capability indications indicating UE support for different PRACH configuration options (e.g., PRACH configuration option 1 or PrACH configuration option 2). Alternatively or additionally, in some aspects, the second capability indication may indicate UE support for a PRACH transmission in a random access occasion across SBFD symbols and non-SBFD symbols.

In some aspects, the second capability indication may indicate UE support for a PRACH transmission associated with one or more random access channel (RACH) operations, such as repetition of a PUSCH transmission in one or more SBFD symbols. The one or more RACH operations may include repetition of the PUSCH transmission scheduled by a random access response uplink grant and downlink control information format 0_0 with a cyclic redundancy check scrambled by a radio network temporary identifier in the one or more SBFD symbols. In some aspects, at least two of the one or more SBFD symbols may have different power control parameters. In some aspects, the one or more RACH operations may include configuring one or more RSRP thresholds for repetitions of PUSCH transmissions in the one or more SBFD symbols. In some aspects, at least one of the one or more RSRP thresholds for repetitions of PUSCH transmissions in the one or more SBFD symbols may be different from at least one of one or more RSRP thresholds for repetitions of PUSCH transmissions in non-SBFD symbols. In some aspects, the PUSCH transmission may be a message 3 RACH communication.

In some aspects, the one or more RACH operations may include repetition of a PUCCH transmission in one or more SBFD symbols. In some aspects, the RACH operation may include the UE 120 applying a configuration for one or more RSRP thresholds for repetition of the PUCCH transmission in the one or more SBFD symbols. In some aspects, the PUCCH transmission may be a message 4 hybrid automatic repeat request (HARQ) acknowledgement (ACK).

In some aspects, the second capability indication may indicate UE support for a first RACH operation in a first random access occasion (e.g., in addition to any random access occasions associated with non-SBFD operation) in SBFD symbols, and the UE 120 may transmit a third capability indication indicating UE support for a PRACH transmission in a second random access occasion in SBFD symbols. In some aspects, the second capability indication may indicate UE support for a resource allocation configured in accordance with PRACH configuration option 1 (e.g., a PRACH configuration with a single set of parameters for all PRACH transmissions within a cell), and the third configuration may indicate UE support for a resource allocation configured in accordance with a PRACH configuration option 2 (e.g., allocation of PRACH resources (e.g., time and frequency slots) to particular groups of UEs).

In some aspects, the second capability indication may indicate UE support for a PUSCH resource element (RE)-level resource muting. The PUSCH RE-level resource muting may be associated with one or more of a CP-OFDM waveform or a DFT-s-OFDM waveform. Alternatively, in some aspects, the UE 120 may provide separate capability indications indicating UE support for PUSCH RE-level resource muting for each of CP-OFDM and DFT-s-OFDM waveforms. In some aspects, the second capability indication may indicate UE support for PUSCH RE-level resource muting in accordance with a configurable comb offset for one or more semi-statically configured uplink resource mapping symbols. Alternatively or in addition, the second capability indication may indicate support for PUSCH RE-level resource muting in accordance with dynamic on/off transmission reception determination availability.

In some aspects, after transmitting the one or more capability reports to the network node 110, the UE 120 may transmit SBFD uplink communications, receive SBFD downlink communications, or a combination thereof, among other examples, in accordance with the first group of primary SBFD operations and one or more of the supplemental SBFD operations.

By transmitting a single capability report indicating UE support for the group of primary SBFD operations, the UE may reduce a total number of capability reports transmitted to the network node, which may reduce network congestion and allow the UE and network node to communicate data via the SBFD symbols 305 sooner than if the UE were required to transmit a separate capability report for each individual SBFD operation.

As indicated above, FIG. 3 is provided as an example. Other examples may differ from what is described with respect to FIG. 3.

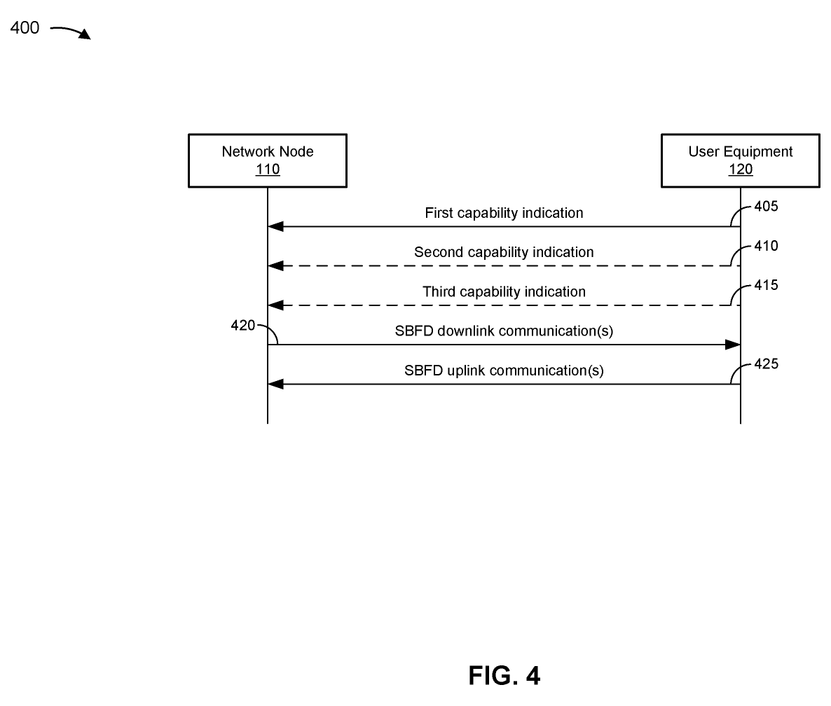

FIG. 4 is a diagram illustrating an example 400 associated with SBFD communication. As shown in FIG. 4, a network node 110 and a UE 120 may communicate with one another.

As shown by reference number 405, the UE 120 may transmit, and the network node 110 may receive, a first capability indication. The first capability indication may indicate UE support for a first group of primary SBFD operations. In some aspects, the group of primary SBFD operations may include transmitting SBFD uplink communications only within uplink sub-bands of SBFD symbols configured in downlink symbols or flexible symbols, receiving SBFD downlink communications only within downlink sub-bands of SBFD symbols configured in downlink symbols or flexible symbols, determining a link direction in accordance with one or more configured or scheduled communications and one or more collision handling rules, and applying a configuration for one or more power control parameters within a unified TCI state for the SBFD uplink communications in SBFD symbols.

As shown by reference number 410, the UE 120 may transmit, and the network node 110 may receive, a second capability indication. In some aspects, the second capability indication may indicate UE support for one or more supplemental SBFD operations. Examples of the supplemental SBFD operations are discussed above with respect to FIG. 3.

As shown by reference number 415, the UE 120 may transmit, and the network node 110 may receive, a third capability indication. In some aspects, as discussed above, the second capability indication may indicate UE support for a resource allocation configured in accordance with PRACH configuration option 1 (e.g., a PRACH configuration with a single set of parameters for all PRACH transmissions within a cell), and the third capability indication may indicate UE support for a resource allocation configured in accordance with a PRACH configuration option 2 (e.g., allocation of PRACH resources (e.g., time and frequency slots) to particular groups of UEs). Alternatively, the third capability indication may indicate UE support for a different supplemental SBFD operation than the SBFD operation indicated by the second capability indication.

As shown by reference number 420, the network node 110 may transmit, and the UE 120 may receive, one or more SBFD downlink communications. In some aspects, as discussed above with respect to FIG. 3, each of the SBFD downlink communications may be transmitted from the network node 110 to the UE 120 in a downlink sub-band (e.g., downlink sub-band 310) of an SBFD symbol (e.g., SBFD symbol 305).

As shown by reference number 425, the UE 120 may transmit, and the network node 110 may receive, one or more SBFD uplink communications. In some aspects, as discussed above with respect to FIG. 3, the SBFD uplink communications may be transmitted from the UE 120 to the network node 110 in uplink sub-bands (e.g., uplink sub-bands 315) of SBFD symbols.

Accordingly, as discussed above, by transmitting a single capability report indicating UE support for the group of primary SBFD operations, the UE may reduce a total number of capability reports transmitted to the network node, which may reduce network congestion and allow the UE and network node to communicate data via the SBFD symbols sooner than if the UE were required to transmit a separate capability report for each individual SBFD operation.

As indicated above, FIG. 4 is provided as an example. Other examples may differ from what is described with respect to FIG. 4.

FIG. 5 is a diagram illustrating an example process 500 performed, in some aspects, at a UE or an apparatus of a UE. Example process 500 is an example where the apparatus or the UE (e.g., UE 120) performs operations associated with SBFD communication.

As shown in FIG. 5, in some aspects, process 500 may include transmitting, to a network node, a first capability indication indicating support for a first group of primary SBFD operations (block 510). In some aspects, the UE (e.g., using transmission component 704 or communication manager 706, depicted in FIG. 7) may transmit, to a network node, a first capability indication indicating support for a first group of primary SBFD operations, as described above. In some aspects, the first group of primary SBFD operations includes two or more of: transmitting SBFD uplink communications only within uplink sub-bands of SBFD symbols configured in downlink symbols or flexible symbols, receiving SBFD downlink communications only within downlink sub-bands of SBFD symbols configured in downlink symbols or flexible symbols, determining a link direction in accordance with one or more configured or scheduled communications and one or more collision handling rules, or configuring (e.g., the UE applying a configuration for) one or more power control parameters within a unified TCI state for the SBFD uplink communications in SBFD symbols.

As further shown in FIG. 5, in some aspects, process 500 may include transmitting the SBFD uplink communications in accordance with the first group of primary SBFD operations (block 520). In some aspects, the UE (e.g., using transmission component 704 or communication manager 706, depicted in FIG. 7) may transmit the SBFD uplink communications in accordance with the first group of primary SBFD operations, as described above.

As further shown in FIG. 5, in some aspects, process 500 may include receiving the SBFD downlink communications in accordance with the first group of primary SBFD operations (block 530). In some aspects, the UE (e.g., using reception component 702 or communication manager 706, depicted in FIG. 7) may receive the SBFD downlink communications in accordance with the first group of primary SBFD operations, as described above.

Process 500 may include additional aspects, such as any single aspect or any combination of aspects described below or in connection with one or more other processes described elsewhere herein.

In a first aspect, process 500 includes transmitting, to the network node, a second capability indication indicating support for one or more supplemental SBFD operations.

In a second aspect, alone or in combination with the first aspect, the one or more supplemental SBFD operations includes applying a configuration for one or more partial resource block groups for a PDSCH or a PUSCH communications using frequency domain resource allocation type 0.

In a third aspect, alone or in combination with one or more of the first and second aspects, the one or more supplemental SBFD operations includes mapping a DMRS sequence to one or more assigned PRBs within one or more downlink sub-bands or one or more uplink sub-bands in one or more PRBs.

In a fourth aspect, alone or in combination with one or more of the first through third aspects, the one or more supplemental SBFD operations includes rate matching a PDSCH for one or more frequency domain resource allocation type 1 narrow-band precoding resource block groups. The one or more PDSCH resources may be mapped to an assigned PRB within a downlink sub-band.

In a fifth aspect, alone or in combination with one or more of the first through fourth aspects, the one or more supplemental SBFD operations includes determining a transport block size in accordance with one or more valid PRBs within one or more downlink sub-bands or within an uplink sub-band and in accordance with a mapping of DMRSs of SBFD symbols to the one or more valid PRBs.

In a sixth aspect, alone or in combination with one or more of the first through fifth aspects, the one or more supplemental SBFD operations includes applying a frequency hopping offset in accordance with a frequency hopping offset list for SBFD uplink PUSCH communications in SBFD symbols.

In a seventh aspect, alone or in combination with one or more of the first through sixth aspects, the one or more supplemental SBFD operations includes configuring one or more frequency hopping resources for SBFD uplink PUCCH communications. The one or more frequency hopping resources may include one or more of a first frequency hop resource block and a second frequency hop resource block for each PUCCH resource.

In an eighth aspect, alone or in combination with one or more of the first through seventh aspects, the one or more supplemental SBFD operations includes configuring a number of downlink sub-bands for downlink scheduling in SBFD symbols.

In a ninth aspect, alone or in combination with one or more of the first through eighth aspects, the number of downlink sub-bands is one or two.

In a tenth aspect, alone or in combination with one or more of the first through ninth aspects, the one or more supplemental SBFD operations includes configuring a minimum guard band between an uplink sub-band and a downlink sub-band.

In an eleventh aspect, alone or in combination with one or more of the first through tenth aspects, the one or more supplemental SBFD operations includes configuring a maximum number of downlink-uplink switches per SBFD slot.

In a twelfth aspect, alone or in combination with one or more of the first through eleventh aspects, the one or more supplemental SBFD operations includes configuring a maximum number of downlink-uplink switches per SBFD or time division duplexing period.

In a thirteenth aspect, alone or in combination with one or more of the first through twelfth aspects, the one or more supplemental SBFD operations includes uplink transmission or downlink reception across different slots, and each slot may be configured with one of only SBFD symbols or only non-SBFD symbols.

In a fourteenth aspect, alone or in combination with one or more of the first through thirteenth aspects, the one or more supplemental SBFD operations includes configuring one or more SRS sets. Each of the one or more SRS sets may be associated with one of SBFD symbols or non-SBFD symbols.

In a fifteenth aspect, alone or in combination with one or more of the first through fourteenth aspects, the one or more supplemental SBFD operations includes transmitting a partial CSI sub-band report.

In a sixteenth aspect, alone or in combination with one or more of the first through fifteenth aspects, the one or more supplemental SBFD operations includes configuring a contiguous CSI-RS resource that overlaps one or more SBFD sub-band boundaries. The contiguous CSI-RS resource may be associated with a downlink PRB.

In a seventeenth aspect, alone or in combination with one or more of the first through sixteenth aspects, the one or more supplemental SBFD operations includes configuring a non-contiguous CSI-RS resource in two or more downlink sub-bands, and reporting a capability associated with a CSI processing timeline.

In an eighteenth aspect, alone or in combination with one or more of the first through seventeenth aspects, the SBFD uplink communications are transmitted in accordance with the first group of primary SBFD operations and the one or more supplemental SBFD operations.

In a nineteenth aspect, alone or in combination with one or more of the first through eighteenth aspects, the SBFD downlink communications are received in accordance with the first group of primary SBFD operations and the one or more supplemental SBFD operations.

In a twentieth aspect, alone or in combination with one or more of the first through nineteenth aspects, process 500 includes transmitting, to the network node, a second capability indication that indicates support for a PRACH transmission with preamble repetition in a set of random access occasions.

In a twenty-first aspect, alone or in combination with one or more of the first through twentieth aspects, process 500 includes transmitting, to the network node, a second capability indication that indicates support for a PRACH transmission in a random access occasion across SBFD symbols and non-SBFD symbols.

In a twenty-second aspect, alone or in combination with one or more of the first through twenty-first aspects, process 500 includes transmitting, to the network node, a second capability indication indicating support for a PRACH transmission associated with one or more RACH operations. The one or more RACH operations may include a first RACH operation in a first random access occasion in SBFD symbols.

In a twenty-third aspect, alone or in combination with one or more of the first through twenty-second aspects, process 500 includes transmitting, to the network node, a third capability indication indicating support of a PRACH transmission in a second random access occasion in SBFD symbols. The second capability indication may indicate support for a PRACH configuration option 1, and the third capability indication indicates support for a PRACH configuration option 2.

In a twenty-fourth aspect, alone or in combination with one or more of the first through twenty-third aspects, process 500 includes transmitting, to the network node, a second capability indication indicating support for a PRACH transmission associated with one or more RACH operations. The one or more RACH operations may include repetition of a PUSCH transmission in one or more SBFD symbols.

In a twenty-fifth aspect, alone or in combination with one or more of the first through twenty-fourth aspects, the one or more RACH operations includes repetition of the PUSCH transmission scheduled by a random access response uplink grant and DCI format 0_0 with a cyclic redundancy check (CRC) scrambled by a radio network temporary identifier in the one or more SBFD symbols. At least two of the one or more SBFD symbols may have different power control parameters.

In a twenty-sixth aspect, alone or in combination with one or more of the first through twenty-fifth aspects, the one or more RACH operations includes configuring one or more RSRP thresholds for repetitions of PUSCH transmissions in the one or more SBFD symbols. At least one of the one or more RSRP thresholds for repetitions of PUSCH transmissions in the one or more SBFD symbols may be different from at least one of one or more RSRP thresholds for repetitions of PUSCH transmissions in non-SBFD symbols.

In a twenty-seventh aspect, alone or in combination with one or more of the first through twenty-sixth aspects, the PUSCH transmission is a message 3 RACH communication.

In a twenty-eighth aspect, alone or in combination with one or more of the first through twenty-seventh aspects, process 500 includes transmitting, to the network node, a second capability indication indicating support for a PRACH transmission associated with one or more RACH operations. The one or more RACH operations may include repetition of a PUCCH transmission in one or more SBFD symbols.

In a twenty-ninth aspect, alone or in combination with one or more of the first through twenty-eighth aspects, the one or more RACH operations includes configuring one or more RSRP thresholds for repetition of the PUCCH transmission in the one or more SBFD symbols.

In a thirtieth aspect, alone or in combination with one or more of the first through twenty-ninth aspects, the PUCCH transmission is a message 4 HARQ ACK.

In a thirty-first aspect, alone or in combination with one or more of the first through thirtieth aspects, process 500 includes transmitting, to the network node, a second capability indication indicating support for PUSCH RE-level resource muting.

In a thirty-second aspect, alone or in combination with one or more of the first through thirty-first aspects, the PUSCH RE-level resource muting is associated with one or more of a CP-OFDM waveform or a DFT-s-OFDM waveform.

In a thirty-third aspect, alone or in combination with one or more of the first through thirty-second aspects, the second capability indication indicates support for PUSCH RE-level resource muting in accordance with a configurable comb offset for one or more semi-statically configured uplink resource mapping symbols.

In a thirty-fourth aspect, alone or in combination with one or more of the first through thirty-third aspects, the second capability indication indicates support for PUSCH RE-level resource muting in accordance with dynamic on/off transmission reception determination availability.

Although FIG. 5 shows example blocks of process 500, in some aspects, process 500 may include additional blocks, fewer blocks, different blocks, or differently arranged blocks than those depicted in FIG. 5. Additionally, or alternatively, two or more of the blocks of process 500 may be performed in parallel.

FIG. 6 is a diagram illustrating an example process 600 performed, in some aspects, at a network node or an apparatus of a network node. Example process 600 is an example where the apparatus or the network node (e.g., network node 110) performs operations associated with SBFD communication.

As shown in FIG. 6, in some aspects, process 600 may include receiving a first capability indication indicating UE support for a first group of primary SBFD operations (block 610). In some aspects, the network node (e.g., using reception component 802 or communication manager 806, depicted in FIG. 8) may receive a first capability indication indicating UE support for a first group of primary SBFD operations, as described above. The first group of primary SBFD operations supported by the UE may include the UE: transmitting SBFD uplink communications only within uplink sub-bands of SBFD symbols configured in downlink symbols or flexible symbols, receiving SBFD downlink communications only within downlink sub-bands of SBFD symbols configured in downlink symbols or flexible symbols, determining a link direction in accordance with one or more configured or scheduled communications and one or more collision handling rules, and applying a configuration for one or more power control parameters within a unified TCI state for the SBFD uplink communications in SBFD symbols (block 620).

As further shown in FIG. 6, in some aspects, process 600 may include receiving the SBFD uplink communications in accordance with the first group of primary SBFD operations (block 620). In some aspects, the network node (e.g., using reception component 802 or communication manager 806, depicted in FIG. 8) may receive the SBFD uplink communications in accordance with the first group of primary SBFD operations, as described above.

As further shown in FIG. 6, in some aspects, process 600 may include transmitting the SBFD downlink communications in accordance with the first group of primary SBFD operations (block 630). In some aspects, the network node (e.g., using transmission component 804 or communication manager 806, depicted in FIG. 8) may transmit the SBFD downlink communications in accordance with the first group of primary SBFD operations, as described above.

Process 600 may include additional aspects, such as any single aspect or any combination of aspects described below or in connection with one or more other processes described elsewhere herein.

In a first aspect, process 600 includes receiving a second capability indication indicating UE support for one or more supplemental SBFD operations.

In a second aspect, alone or in combination with the first aspect, the one or more supplemental SBFD operations supported by the UE includes the UE applying a configuration for one or more partial resource block groups for a PDSCH or a PUSCH communications using frequency domain resource allocation type 0.

In a third aspect, alone or in combination with one or more of the first and second aspects, the one or more supplemental SBFD operations supported by the UE includes the UE mapping a DMRS sequence to one or more assigned PRBs within one or more downlink sub-bands or one or more uplink sub-bands in one or more PRBs.

In a fourth aspect, alone or in combination with one or more of the first through third aspects, the one or more supplemental SBFD operations supported by the UE includes the UE rate matching a PDSCH for one or more frequency domain resource allocation type 1 narrow-band precoding resource block groups. The one or more PDSCH resources may be mapped to an assigned PRB within a downlink sub-band.

In a fifth aspect, alone or in combination with one or more of the first through fourth aspects, the one or more supplemental SBFD operations supported by the UE includes the UE determining a transport block size in accordance with one or more valid PRBs within one or more downlink sub-bands or within an uplink sub-band and in accordance with a mapping of DMRSs of SBFD symbols to the one or more valid PRBs.

In a sixth aspect, alone or in combination with one or more of the first through fifth aspects, the one or more supplemental SBFD operations supported by the UE includes the UE applying a frequency hopping offset in accordance with a frequency hopping offset list for SBFD uplink PUSCH communications in SBFD symbols.

In a seventh aspect, alone or in combination with one or more of the first through sixth aspects, the one or more supplemental SBFD operations supported by the UE includes the UE configuring one or more frequency hopping resources for SBFD uplink PUCCH communications. The one or more frequency hopping resources may include one or more of a first frequency hop resource block and a second frequency hop resource block for each PUCCH resource.

In an eighth aspect, alone or in combination with one or more of the first through seventh aspects, the one or more supplemental SBFD operations supported by the UE includes the UE configuring a number of downlink sub-bands for downlink scheduling in SBFD symbols.

In a ninth aspect, alone or in combination with one or more of the first through eighth aspects, the number of downlink sub-bands is one or two.

In a tenth aspect, alone or in combination with one or more of the first through ninth aspects, the one or more supplemental SBFD operations supported by the UE includes the UE configuring a minimum guard band between an uplink sub-band and a downlink sub-band.

In an eleventh aspect, alone or in combination with one or more of the first through tenth aspects, the one or more supplemental SBFD operations supported by the UE includes the UE configuring a maximum number of downlink-uplink switches per SBFD slot.

In a twelfth aspect, alone or in combination with one or more of the first through eleventh aspects, the one or more supplemental SBFD operations supported by the UE includes the UE configuring a maximum number of downlink-uplink switches per SBFD or time division duplexing period.

In a thirteenth aspect, alone or in combination with one or more of the first through twelfth aspects, the one or more supplemental SBFD operations supported by the UE includes uplink transmission or downlink reception, by the UE, across different slots. Each slot may be configured with one of only SBFD symbols or only non-SBFD symbols.

In a fourteenth aspect, alone or in combination with one or more of the first through thirteenth aspects, the one or more supplemental SBFD operations supported by the UE includes the UE configuring one or more SRS sets. Each of the one or more SRS sets may be associated with one of SBFD symbols or non-SBFD symbols.

In a fifteenth aspect, alone or in combination with one or more of the first through fourteenth aspects, the one or more supplemental SBFD operations supported by the UE includes the UE transmitting a partial CSI sub-band report.

In a sixteenth aspect, alone or in combination with one or more of the first through fifteenth aspects, the one or more supplemental SBFD operations supported by the UE includes the UE configuring a contiguous CSI-RS resource that overlaps one or more SBFD sub-band boundaries. The contiguous CSI-RS resource is associated with a downlink PRB.

In a seventeenth aspect, alone or in combination with one or more of the first through sixteenth aspects, the one or more supplemental SBFD operations supported by the UE includes the UE applying a configuration for a non-contiguous CSI-RS resource in two or more downlink sub-bands, and reporting a capability associated with a CSI processing timeline.

In an eighteenth aspect, alone or in combination with one or more of the first through seventeenth aspects, process 600 includes receiving a second capability indication that indicates UE support for a PRACH transmission with preamble repetition in a set of random access occasions.

In a nineteenth aspect, alone or in combination with one or more of the first through eighteenth aspects, process 600 includes receiving a second capability indication that indicates UE support for a PRACH transmission in a random access occasion across SBFD symbols and non-SBFD symbols.

In a twentieth aspect, alone or in combination with one or more of the first through nineteenth aspects, process 600 includes receiving a second capability indication that indicates UE support for a PRACH transmission associated with one or more RACH operations. The one or more RACH operations includes a first RACH operation in a first random access occasion in SBFD symbols.

In a twenty-first aspect, alone or in combination with one or more of the first through twentieth aspects, process 600 includes receiving a third capability indication that indicates UE support for a PRACH transmission in a second random access occasion in SBFD symbols. The second capability indication may indicate UE support for a PRACH configuration option 1, and a third capability indication may indicate UE support for a PRACH configuration option 2.

In a twenty-second aspect, alone or in combination with one or more of the first through twenty-first aspects, process 600 includes receiving a second capability indication that indicates UE support for a PRACH transmission associated with one or more RACH operations. The one or more RACH operations may include repetition of a PUSCH transmission in one or more SBFD symbols.

In a twenty-third aspect, alone or in combination with one or more of the first through twenty-second aspects, the one or more RACH operations includes repetition of the PUSCH transmission scheduled by a random access response uplink grant and DCI format 0_0 with a CRC scrambled by a radio network temporary identifier in the one or more SBFD symbols, and at least two of the one or more SBFD symbols have different power control parameters.

In a twenty-fourth aspect, alone or in combination with one or more of the first through twenty-third aspects, the one or more RACH operations includes the UE applying a configuration for one or more reference signal received power (RSRP) thresholds for repetitions of PUSCH transmissions in the one or more SBFD symbols, and at least one of the one or more RSRP thresholds for repetitions of PUSCH transmissions in the one or more SBFD symbols is different from at least one of one or more RSRP thresholds for repetitions of PUSCH transmissions in non-SBFD symbols.

In a twenty-fifth aspect, alone or in combination with one or more of the first through twenty-fourth aspects, the PUSCH transmission is a message 3 RACH communication.

In a twenty-sixth aspect, alone or in combination with one or more of the first through twenty-fifth aspects, process 600 includes receiving a second capability indication that indicates UE support for a PRACH transmission associated with one or more RACH operations, and the one or more RACH operations includes repetition of a PUCCH transmission in one or more SBFD symbols.

In a twenty-seventh aspect, alone or in combination with one or more of the first through twenty-sixth aspects, the one or more RACH operations includes the UE applying a configuration for one or more reference signal received power thresholds for repetition of the PUCCH transmission in the one or more SBFD symbols.

In a twenty-eighth aspect, alone or in combination with one or more of the first through twenty-seventh aspects, the PUCCH transmission is a message 4 hybrid automatic repeat request acknowledgement.

In a twenty-ninth aspect, alone or in combination with one or more of the first through twenty-eighth aspects, process 600 includes receiving a second capability indication that indicates UE support for PUSCH RE-level resource muting.

In a thirtieth aspect, alone or in combination with one or more of the first through twenty-ninth aspects, the PUSCH RE-level resource muting is associated with one or more of a CP-OFDM waveform or a DFT-s-OFDM waveform.

In a thirty-first aspect, alone or in combination with one or more of the first through thirtieth aspects, the second capability indication indicates UE support for PUSCH RE-level resource muting in accordance with a configurable comb offset for one or more semi-statically configured uplink resource mapping symbols.

In a thirty-second aspect, alone or in combination with one or more of the first through thirty-first aspects, the second capability indication indicates UE support for PUSCH RE-level resource muting in accordance with dynamic on/off transmission reception determination availability.

Although FIG. 6 shows example blocks of process 600, in some aspects, process 600 may include additional blocks, fewer blocks, different blocks, or differently arranged blocks than those depicted in FIG. 6. Additionally, or alternatively, two or more of the blocks of process 600 may be performed in parallel.

FIG. 7 is a diagram of an example apparatus 700 for wireless communication. The apparatus 700 may be a UE, or a UE may include the apparatus 700. In some aspects, the apparatus 700 includes a reception component 702, a transmission component 704, or a communication manager 706, which may be in communication with one another (for example, via one or more buses or one or more other components). In some aspects, the communication manager 706 is the communication manager 150 described in connection with FIG. 1. As shown, the apparatus 700 may communicate with another apparatus 708, such as a UE or a network node (such as a CU, a DU, an RU, or a base station), using the reception component 702 and the transmission component 704. The communication manager 706 may be included in, or implemented via, a processing system (for example, the processing system 140 described in connection with FIG. 1) of the UE.

In some aspects, the apparatus 700 may be configured to perform one or more operations described herein in connection with FIGS. 3-4. Additionally, or alternatively, the apparatus 700 may be configured to perform one or more processes described herein, such as process 500 of FIG. 5. In some aspects, the apparatus 700 or one or more components shown in FIG. 7 may include one or more components of the UE described in connection with FIG. 1. Additionally, or alternatively, one or more components shown in FIG. 7 may be implemented within one or more components described in connection with FIG. 1. Additionally, or alternatively, one or more components of the set of components may be implemented at least in part as software stored in one or more memories. In some aspects, a component (or a portion of a component) may be implemented as instructions or code stored in a non-transitory computer-readable medium and executable by one or more controllers or one or more processors to perform the functions or operations of the component.

The reception component 702 may receive communications, such as reference signals, control information, data communications, or a combination thereof, from the apparatus 708. The reception component 702 may provide received communications to one or more other components of the apparatus 700. In some aspects, the reception component 702 may perform signal processing on the received communications, and may provide the processed signals to the one or more other components of the apparatus 700. In some aspects, the reception component 702 may include one or more components of the UE described above in connection with FIG. 1, such as a radio, one or more RF chains, one or more transceivers, or one or more modems, each of which may in turn be coupled with one or more antennas of the UE.

The transmission component 704 may transmit communications, such as reference signals, control information, data communications, or a combination thereof, to the apparatus 708. In some aspects, one or more other components of the apparatus 700 may generate communications and may provide the generated communications to the transmission component 704 for transmission to the apparatus 708. In some aspects, the transmission component 704 may perform signal processing on the generated communications, and may transmit the processed signals to the apparatus 708. In some aspects, the transmission component 704 may include one or more components of the UE described above in connection with FIG. 1, such as a radio, one or more RF chains, one or more transceivers, or one or more modems, each of which may in turn be coupled with one or more antennas of the UE described in connection with FIG. 1. In some aspects, the transmission component 704 may be co-located with the reception component 702.

The communication manager 706 may support operations of the reception component 702 or the transmission component 704. In some aspects, the communication manager 706 may receive information associated with configuring reception of communications by the reception component 702 or transmission of communications by the transmission component 704. Additionally, or alternatively, the communication manager 706 may generate or provide control information to the reception component 702 or the transmission component 704 to control reception or transmission of communications.

The transmission component 704 may transmit, to a network node, a first capability indication indicating support for a first group of primary SBFD operations. As discussed above, the first group of primary SBFD operations may include transmitting SBFD uplink communications only within uplink sub-bands of SBFD symbols configured in downlink symbols or flexible symbols, receiving SBFD downlink communications only within downlink sub-bands of SBFD symbols configured in downlink symbols or flexible symbols, determining a link direction in accordance with one or more configured or scheduled communications and one or more collision handling rules, and applying a configuration for one or more power control parameters within a unified TCI state for the SBFD uplink communications in SBFD symbols. The transmission component 704 may transmit the SBFD uplink communications in accordance with the first group of primary SBFD operations. The reception component 702 may receive the SBFD downlink communications in accordance with the first group of primary SBFD operations. The transmission component 704 may transmit, to the network node, a second capability indication indicating support for one or more supplemental SBFD operations. The transmission component 704 may transmit, to the network node, a second capability indication that indicates support for a PRACH transmission with preamble repetition in a set of random access occasions. The transmission component 704 may transmit, to the network node, a second capability indication that indicates support for a PRACH transmission in a random access occasion across SBFD symbols and non-SBFD symbols. The transmission component 704 may transmit, to the network node, a second capability indication indicating support for a PRACH transmission associated with one or more RACH operations, wherein the one or more RACH operations includes a first RACH operation in a first random access occasion in SBFD symbols. The transmission component 704 may transmit, to the network node, a third capability indication indicating support of a PRACH transmission in a second random access occasion in SBFD symbols wherein the second capability indication indicates support for a PRACH configuration option 1, and wherein the third capability indication indicates support for a PRACH configuration option 2. The transmission component 704 may transmit, to the network node, a second capability indication indicating support for a PRACH transmission associated with one or more RACH operations, wherein the one or more RACH operations includes repetition of a PUSCH transmission in one or more SBFD symbols. The transmission component 704 may transmit, to the network node, a second capability indication indicating support for a PRACH transmission associated with one or more RACH operations, wherein the one or more RACH operations includes repetition of a PUCCH transmission in one or more SBFD symbols. The transmission component 704 may transmit, to the network node, a second capability indication indicating support for PUSCH RE-level resource muting.

The number and arrangement of components shown in FIG. 7 are provided as an example. In practice, there may be additional components, fewer components, different components, or differently arranged components than those shown in FIG. 7. Furthermore, two or more components shown in FIG. 7 may be implemented within a single component, or a single component shown in FIG. 7 may be implemented as multiple, distributed components. Additionally, or alternatively, a set of (one or more) components shown in FIG. 7 may perform one or more functions described as being performed by another set of components shown in FIG. 7.

FIG. 8 is a diagram of an example apparatus 800 for wireless communication. The apparatus 800 may be a network node, or a network node may include the apparatus 800. In some aspects, the apparatus 800 includes a reception component 802, a transmission component 804, or a communication manager 806, which may be in communication with one another (for example, via one or more buses or one or more other components). In some aspects, the communication manager 806 is the communication manager 155 described in connection with FIG. 1. As shown, the apparatus 800 may communicate with another apparatus 808, such as a UE or a network node (such as a CU, a DU, an RU, or a base station), using the reception component 802 and the transmission component 804. The communication manager 806 may be included in, or implemented via, a processing system (for example, the processing system 145 described in connection with FIG. 1) of the network node.

In some aspects, the apparatus 800 may be configured to perform one or more operations described herein in connection with FIGS. 3-4. Additionally, or alternatively, the apparatus 800 may be configured to perform one or more processes described herein, such as process 600 of FIG. 6. In some aspects, the apparatus 800 or one or more components shown in FIG. 8 may include one or more components of the network node described in connection with FIG. 1. Additionally, or alternatively, one or more components shown in FIG. 8 may be implemented within one or more components described in connection with FIG. 1. Additionally, or alternatively, one or more components of the set of components may be implemented at least in part as software stored in one or more memories. In some aspects, a component (or a portion of a component) may be implemented as instructions or code stored in a non-transitory computer-readable medium and executable by one or more controllers or one or more processors to perform the functions or operations of the component.

The reception component 802 may receive communications, such as reference signals, control information, data communications, or a combination thereof, from the apparatus 808. The reception component 802 may provide received communications to one or more other components of the apparatus 800. In some aspects, the reception component 802 may perform signal processing on the received communications, and may provide the processed signals to the one or more other components of the apparatus 800. In some aspects, the reception component 802 may include one or more components of the network node described above in connection with FIG. 1, such as a radio, one or more RF chains, one or more transceivers, or one or more modems, each of which may in turn be coupled with one or more antennas of the network node. In some aspects, the reception component 802 or the transmission component 804 may include or may be included in a network interface. The network interface may be configured to obtain or output signals for the apparatus 800 via one or more communications links, such as a backhaul link, a midhaul link, or a fronthaul link.

The transmission component 804 may transmit communications, such as reference signals, control information, data communications, or a combination thereof, to the apparatus 808. In some aspects, one or more other components of the apparatus 800 may generate communications and may provide the generated communications to the transmission component 804 for transmission to the apparatus 808. In some aspects, the transmission component 804 may perform signal processing on the generated communications, and may transmit the processed signals to the apparatus 808. In some aspects, the transmission component 804 may include one or more components of the network node described above in connection with FIG. 1, such as a radio, one or more RF chains, one or more transceivers, or one or more modems, each of which may in turn be coupled with one or more antennas of the network node described in connection with FIG. 1. In some aspects, the transmission component 804 may be co-located with the reception component 802.

The communication manager 806 may support operations of the reception component 802 or the transmission component 804. In some aspects, the communication manager 806 may receive information associated with configuring reception of communications by the reception component 802 or transmission of communications by the transmission component 804. Additionally, or alternatively, the communication manager 806 may generate or provide control information to the reception component 802 or the transmission component 804 to control reception or transmission of communications.

The reception component 802 may receive a first capability indication indicating UE support for a first group of primary SBFD operations. The first group of primary SBFD operations supported by the UE includes the UE transmitting SBFD uplink communications only within uplink sub-bands of SBFD symbols configured in downlink symbols or flexible symbols, receiving SBFD downlink communications only within downlink sub-bands of SBFD symbols configured in downlink symbols or flexible symbols, determining a link direction in accordance with one or more configured or scheduled communications and one or more collision handling rules, and applying a configuration for one or more power control parameters within a unified TCI state for the SBFD uplink communications in SBFD symbols. The reception component 802 may receive the SBFD uplink communications in accordance with the first group of primary SBFD operations. The transmission component 804 may transmit the SBFD downlink communications in accordance with the first group of primary SBFD operations.

The reception component 802 may receive a second capability indication indicating UE support for one or more supplemental SBFD operations. The reception component 802 may receive a second capability indication that indicates UE support for a PRACH transmission with preamble repetition in a set of random access occasions. The reception component 802 may receive a second capability indication that indicates UE support for a PRACH transmission in a random access occasion across SBFD symbols and non-SBFD symbols. The reception component 802 may receive a second capability indication that indicates UE support for a PRACH transmission associated with one or more RACH operations, wherein the one or more RACH operations includes a first RACH operation in a first random access occasion in SBFD symbols. The reception component 802 may receive a third capability indication that indicates UE support for a PRACH transmission in a second random access occasion in SBFD symbols wherein the second capability indication indicates UE support for a PRACH configuration option 1, and wherein a third capability indication indicates UE support for a PRACH configuration option 2. The reception component 802 may receive a second capability indication that indicates UE support for a PRACH transmission associated with one or more RACH operations, wherein the one or more RACH operations includes repetition of a PUSCH transmission in one or more SBFD symbols. The reception component 802 may receive a second capability indication that indicates UE support for a PRACH transmission associated with one or more RACH operations, wherein the one or more RACH operations includes repetition of a PUCCH transmission in one or more SBFD symbols. The reception component 802 may receive a second capability indication that indicates UE support for PUSCH RE-level resource muting.

The number and arrangement of components shown in FIG. 8 are provided as an example. In practice, there may be additional components, fewer components, different components, or differently arranged components than those shown in FIG. 8. Furthermore, two or more components shown in FIG. 8 may be implemented within a single component, or a single component shown in FIG. 8 may be implemented as multiple, distributed components. Additionally, or alternatively, a set of (one or more) components shown in FIG. 8 may perform one or more functions described as being performed by another set of components shown in FIG. 8.

### The following provides an overview of some Aspects of the present disclosure

Aspect 1: A method of wireless communication at a UE, comprising: transmitting, to a network node, a first capability indication indicating support for a first group of primary SBFD operations, wherein the first group of primary SBFD operations includes two or more of: transmitting SBFD uplink communications only within uplink sub-bands of SBFD symbols configured in downlink symbols or flexible symbols, receiving SBFD downlink communications only within downlink sub-bands of SBFD symbols configured in downlink symbols or flexible symbols, determining a link direction in accordance with one or more configured or scheduled communications and one or more collision handling rules, applying a configuration for one or more power control parameters within a unified TCI state for the SBFD uplink communications in SBFD symbols, configuring a maximum number of downlink-uplink switches per SBFD slot, configuring a maximum number of downlink-uplink switches per SBFD or time division duplexing period, configuring one or more sounding reference signal (SRS) sets, wherein each of the one or more SRS sets is associated with one of SBFD symbols or non-SBFD symbols, or configuring a contiguous or non-contiguous channel state information reference signal resource that overlaps one or more SBFD sub-band boundaries; transmitting the SBFD uplink communications in accordance with the first group of primary SBFD operations; and receiving the SBFD downlink communications in accordance with the first group of primary SBFD operations.

Aspect 2: The method of Aspect 1, further comprising transmitting, to the network node, a second capability indication indicating support for one or more supplemental SBFD operations.

Aspect 3: The method of Aspect 2, wherein the one or more supplemental SBFD operations includes applying a configuration for one or more partial resource block groups for a PDSCH or a PUSCH communications using frequency domain resource allocation type 0.

Aspect 4: The method of any of Aspects 2-3, wherein the one or more supplemental SBFD operations includes mapping a DMRS sequence to one or more assigned PRBs within one or more downlink sub-bands or one or more uplink sub-bands in one or more PRBs.

Aspect 5: The method of any of Aspects 2-4, wherein the one or more supplemental SBFD operations includes rate matching a PDSCH for one or more frequency domain resource allocation type 1 narrow-band precoding resource block groups, wherein one or more PDSCH resources are mapped to an assigned PRB within a downlink sub-band.

Aspect 6: The method of any of Aspects 2-5, wherein the first group of primary SBFD operations or the one or more supplemental SBFD operations includes determining a transport block size in accordance with one or more valid PRBs within one or more downlink sub-bands or within an uplink sub-band and in accordance with a mapping of DMRSs of SBFD symbols to the one or more valid PRBs.

Aspect 7: The method of any of Aspects 2-6, wherein the first group of primary SBFD operations or the one or more supplemental SBFD operations includes applying a frequency hopping offset in accordance with a frequency hopping offset list for SBFD uplink PUSCH communications in SBFD symbols.

Aspect 8: The method of any of Aspects 2-7, wherein the first group of primary SBFD operations or the one or more supplemental SBFD operations includes configuring one or more frequency hopping resources for SBFD uplink PUCCH communications, wherein the one or more frequency hopping resources includes one or more of a first frequency hop resource block and a second frequency hop resource block for each PUCCH resource.

Aspect 9: The method of any of Aspects 2-8, wherein the one or more supplemental SBFD operations includes configuring a number of downlink sub-bands for downlink scheduling in SBFD symbols.

Aspect 10: The method of Aspect 9, wherein the number of downlink sub-bands is one or two.

Aspect 11: The method of any of Aspects 2-10, wherein the one or more supplemental SBFD operations includes configuring a minimum guard band between an uplink sub-band and a downlink sub-band.

Aspect 12: The method of any of Aspects 1-11, wherein the first group of primary SBFD operations further includes configuring a maximum number of downlink-uplink switches per SBFD slot.

Aspect 13: The method of any of Aspects 1-12, wherein the first group of primary SBFD operations further includes configuring a maximum number of downlink-uplink switches per SBFD or time division duplexing period.

Aspect 14: The method of any of Aspects 2-13, wherein the first group of primary SBFD operations or the one or more supplemental SBFD operations includes uplink transmission or downlink reception across different slots, wherein each slot is configured with one of only SBFD symbols or only non-SBFD symbols.

Aspect 15: The method of any of Aspects 1-14, wherein the first group of primary SBFD operations further includes configuring one or more SRS sets, wherein each of the one or more SRS sets is associated with one of SBFD symbols or non-SBFD symbols.

Aspect 16: The method of any of Aspects 2-17, wherein the one or more supplemental SBFD operations includes transmitting a partial CSI sub-band report.

Aspect 17: The method of any of Aspects 1-17, wherein the first group of primary SBFD operations further includes configuring a contiguous CSI-RS resource that overlaps one or more SBFD sub-band boundaries, wherein the contiguous CSI-RS resource is associated with a downlink PRB.

Aspect 18: The method of any of Aspects 1-17, wherein the first group of primary SBFD operations further includes: configuring a non-contiguous CSI-RS resource in two or more downlink sub-bands; and reporting a capability associated with a CSI processing timeline.

Aspect 19: The method of any of Aspects 2-18, wherein the SBFD uplink communications are transmitted in accordance with the first group of primary SBFD operations and the one or more supplemental SBFD operations.

Aspect 20: The method of any of Aspects 2-19, wherein the SBFD downlink communications are received in accordance with the first group of primary SBFD operations and the one or more supplemental SBFD operations.

Aspect 21: The method of any of Aspects 1-20, further comprising transmitting, to the network node, a second capability indication that indicates support for a PRACH transmission with preamble repetition in a set of random access occasions.

Aspect 22: The method of any of Aspects 1-21, further comprising transmitting, to the network node, a second capability indication that indicates support for a PRACH transmission in a random access occasion across SBFD symbols and non-SBFD symbols.

Aspect 23: The method of any of Aspects 1-22, further comprising transmitting, to the network node, a second capability indication indicating support for a PRACH transmission associated with one or more RACH operations, wherein the one or more RACH operations includes a first RACH operation in a first random access occasion in SBFD symbols.

Aspect 24: The method of Aspect 23, further comprising transmitting, to the network node, a third capability indication indicating support of a PRACH transmission in a second random access occasion in SBFD symbols, wherein the second capability indication indicates support for SBFD random access using a first PRACH configuration, and wherein the third capability indication indicates support for SBFD random access using a second PRACH configuration.

Aspect 25: The method of any of Aspects 1-24, further comprising transmitting, to the network node, a second capability indication indicating support for a PRACH transmission associated with one or more RACH operations, wherein the one or more RACH operations includes repetition of a PUSCH transmission in one or more SBFD symbols.

Aspect 26: The method of Aspect 25, wherein the one or more RACH operations includes repetition of the PUSCH transmission scheduled by a random access response uplink grant and DCI format 0_0 with a CRC scrambled by a radio network temporary identifier in the one or more SBFD symbols, wherein at least two of the one or more SBFD symbols have different power control parameters.

Aspect 27: The method of Aspect 25, wherein the one or more RACH operations includes configuring one or more reference signal received power (RSRP) thresholds for repetitions of PUSCH transmissions in the one or more SBFD symbols, wherein at least one of the one or more RSRP thresholds for repetitions of PUSCH transmissions in the one or more SBFD symbols is different from at least one of one or more RSRP thresholds for repetitions of PUSCH transmissions in non-SBFD symbols.

Aspect 28: The method of Aspect 25, wherein the PUSCH transmission is a message 3 RACH communication.

Aspect 29: The method of any of Aspects 1-28, further comprising transmitting, to the network node, a second capability indication indicating support for a PRACH transmission associated with one or more RACH operations, wherein the one or more RACH operations includes repetition of a PUCCH transmission in one or more SBFD symbols.

Aspect 30: The method of Aspect 29, wherein the one or more RACH operations includes configuring one or more reference signal received power thresholds for repetition of the PUCCH transmission in the one or more SBFD symbols.

Aspect 31: The method of Aspect 29, wherein the PUCCH transmission is a message 4 hybrid automatic repeat request acknowledgement.

Aspect 32: The method of any of Aspects 1-31, further comprising transmitting, to the network node, a second capability indication indicating support for PUSCH RE-level resource muting.

Aspect 33: The method of Aspect 32, wherein the PUSCH RE-level resource muting is associated with one or more of a CP-OFDM waveform or a DFT-s-OFDM waveform.

Aspect 34: The method of Aspect 32, wherein the second capability indication indicates support for PUSCH RE-level resource muting in accordance with a configurable comb offset for one or more semi-statically configured uplink resource mapping symbols.

Aspect 35: The method of Aspect 32, wherein the second capability indication indicates support for PUSCH RE-level resource muting in accordance with dynamic on/off transmission reception determination availability.

Aspect 36: A method of wireless communication performed by a network node, comprising: receiving a first capability indication indicating UE support for a first group of primary SBFD operations, wherein the first group of primary SBFD operations supported by the UE includes two or more of: transmitting SBFD uplink communications only within uplink sub-bands of SBFD symbols configured in downlink symbols or flexible symbols, receiving SBFD downlink communications only within downlink sub-bands of SBFD symbols configured in downlink symbols or flexible symbols, determining a link direction in accordance with one or more configured or scheduled communications and one or more collision handling rules, applying a configuration for one or more power control parameters within a unified TCI state for the SBFD uplink communications in SBFD symbols, configuring a maximum number of downlink-uplink switches per SBFD slot, configuring a maximum number of downlink-uplink switches per SBFD or time division duplexing period, configuring one or more sounding reference signal (SRS) sets, wherein each of the one or more SRS sets is associated with one of SBFD symbols or non-SBFD symbols, or configuring a contiguous or non-contiguous channel state information reference signal resource that overlaps one or more SBFD sub-band boundaries; receiving the SBFD uplink communications in accordance with the first group of primary SBFD operations; and transmitting the SBFD downlink communications in accordance with the first group of primary SBFD operations.

Aspect 37: The method of Aspect 36, further comprising receiving a second capability indication indicating UE support for one or more supplemental SBFD operations.

Aspect 38: The method of Aspect 37, wherein the one or more supplemental SBFD operations supported by the UE includes the UE applying a configuration for one or more partial resource block groups for a PDSCH or a PUSCH communications using frequency domain resource allocation type 0.

Aspect 39: The method of any of Aspects 37-38, wherein the one or more supplemental SBFD operations supported by the UE includes the UE mapping a DMRS sequence to one or more assigned PRBs within one or more downlink sub-bands or one or more uplink sub-bands in one or more PRBs.

Aspect 40: The method of any of Aspects 37-39, wherein the one or more supplemental SBFD operations supported by the UE includes the UE rate matching a PDSCH for one or more frequency domain resource allocation type 1 narrow-band precoding resource block groups, wherein one or more PDSCH resources are mapped to an assigned PRB within a downlink sub-band.

Aspect 41: The method of any of Aspects 37-40, wherein the one or more supplemental SBFD operations supported by the UE includes the UE determining a transport block size in accordance with one or more valid PRBs within one or more downlink sub-bands or within an uplink sub-band and in accordance with a mapping of DMRSs of SBFD symbols to the one or more valid PRBs.

Aspect 42: The method of any of Aspects 37-41, wherein the first group of primary SBFD operations supported by the UE or the one or more supplemental SBFD operations supported by the UE includes the UE applying a frequency hopping offset in accordance with a frequency hopping offset list for SBFD uplink PUSCH communications in SBFD symbols.

Aspect 43: The method of any of Aspects 37-42, wherein the first group of primary SBFD operations supported by the UE or the one or more supplemental SBFD operations supported by the UE includes the UE configuring one or more frequency hopping resources for SBFD uplink PUCCH communications, wherein the one or more frequency hopping resources includes one or more of a first frequency hop resource block and a second frequency hop resource block for each PUCCH resource.

Aspect 44: The method of any of Aspects 37-43, wherein the first group of primary SBFD operations supported by the UE or the one or more supplemental SBFD operations supported by the UE includes the UE configuring a number of downlink sub-bands for downlink scheduling in SBFD symbols.

Aspect 45: The method of Aspect 44, wherein the number of downlink sub-bands is one or two.

Aspect 46: The method of any of Aspects 37-45, wherein the one or more supplemental SBFD operations supported by the UE includes the UE configuring a minimum guard band between an uplink sub-band and a downlink sub-band.

Aspect 47: The method of any of Aspects 36-46, wherein the first group of primary SBFD operations supported by the UE further includes configuring a maximum number of downlink-uplink switches per SBFD slot.

Aspect 48: The method of any of Aspects 36-47, wherein the first group of primary SBFD operations supported by the UE further includes configuring a maximum number of downlink-uplink switches per SBFD or time division duplexing period.

Aspect 49: The method of any of Aspects 37-48, wherein the first group of primary SBFD operations supported by the UE or the one or more supplemental SBFD operations supported by the UE includes uplink transmission or downlink reception, by the UE, across different slots, wherein each slot is configured with one of only SBFD symbols or only non-SBFD symbols.

Aspect 50: The method of any of Aspects 36-49, wherein the first group of primary SBFD operations supported by the UE further includes configuring one or more SRS sets, wherein each of the one or more SRS sets is associated with one of SBFD symbols or non-SBFD symbols.

Aspect 51: The method of any of Aspects 37-50, wherein the one or more supplemental SBFD operations supported by the UE includes the UE transmitting a partial CSI sub-band report.

Aspect 52: The method of any of Aspects 36-51, wherein the first group of primary SBFD operations supported by the UE further includes configuring a contiguous CSI-RS resource that overlaps one or more SBFD sub-band boundaries, wherein the contiguous CSI-RS resource is associated with a downlink PRB.

Aspect 53: The method of any of Aspects 36-52, wherein the first group of primary SBFD operations supported by the UE further includes: applying a configuration for a non-contiguous CSI-RS resource in two or more downlink sub-bands; and reporting a capability associated with a CSI processing timeline.

Aspect 54: The method of any of Aspects 36-53, further comprising receiving a second capability indication that indicates UE support for a PRACH transmission with preamble repetition in a set of random access occasions.

Aspect 55: The method of any of Aspects 36-54, further comprising receiving a second capability indication that indicates UE support for a PRACH transmission in a random access occasion across SBFD symbols and non-SBFD symbols.

Aspect 56: The method of any of Aspects 36-55, further comprising receiving a second capability indication that indicates UE support for a PRACH transmission associated with one or more RACH operations, wherein the one or more RACH operations includes a first RACH operation in a first random access occasion in SBFD symbols.

Aspect 57: The method of Aspect 56, further comprising receiving a third capability indication that indicates UE support for a PRACH transmission in a second random access occasion in SBFD symbols, wherein the second capability indication indicates UE support for SBFD random access using a first PRACH configuration, and wherein a third capability indication indicates UE support for SBFD random access using a second PRACH configuration.

Aspect 58: The method of any of Aspects 36-57, further comprising receiving a second capability indication that indicates UE support for a PRACH transmission associated with one or more RACH operations, wherein the one or more RACH operations includes repetition of a PUSCH transmission in one or more SBFD symbols.

Aspect 59: The method of Aspect 58, wherein the one or more RACH operations includes repetition of the PUSCH transmission scheduled by a random access response uplink grant and DCI format 0_0 with a CRC scrambled by a radio network temporary identifier in the one or more SBFD symbols, wherein at least two of the one or more SBFD symbols have different power control parameters.

Aspect 60: The method of Aspect 58, wherein the one or more RACH operations includes the UE applying a configuration for one or more reference signal received power (RSRP) thresholds for repetitions of PUSCH transmissions in the one or more SBFD symbols, wherein at least one of the one or more RSRP thresholds for repetitions of PUSCH transmissions in the one or more SBFD symbols is different from at least one of one or more RSRP thresholds for repetitions of PUSCH transmissions in non-SBFD symbols.

Aspect 61: The method of Aspect 58, wherein the PUSCH transmission is a message 3 RACH communication.

Aspect 62: The method of any of Aspects 36-61, further comprising receiving a second capability indication that indicates UE support for a PRACH transmission associated with one or more RACH operations, wherein the one or more RACH operations includes repetition of a PUCCH transmission in one or more SBFD symbols.

Aspect 63: The method of Aspect 62, wherein the one or more RACH operations includes the UE applying a configuration for one or more reference signal received power thresholds for repetition of the PUCCH transmission in the one or more SBFD symbols.

Aspect 64: The method of Aspect 62, wherein the PUCCH transmission is a message 4 hybrid automatic repeat request acknowledgement.

Aspect 65: The method of any of Aspects 36-64, further comprising receiving a second capability indication that indicates UE support for PUSCH RE-level resource muting.

Aspect 66: The method of Aspect 65, wherein the PUSCH RE-level resource muting is associated with one or more of a CP-OFDM waveform or a DFT-s-OFDM waveform.

Aspect 67: The method of Aspect 65, wherein the second capability indication indicates UE support for PUSCH RE-level resource muting in accordance with a configurable comb offset for one or more semi-statically configured uplink resource mapping symbols.

Aspect 68: The method of Aspect 65, wherein the second capability indication indicates UE support for PUSCH RE-level resource muting in accordance with dynamic on/off transmission reception determination availability.

Aspect 69: An apparatus for wireless communication at a device, the apparatus comprising one or more processors; one or more memories coupled with the one or more processors; and instructions stored in the one or more memories and executable by the one or more processors to cause the apparatus to perform the method of one or more of Aspects 1-68.

Aspect 70: An apparatus for wireless communication at a device, the apparatus comprising one or more memories and one or more processors coupled to the one or more memories, the one or more processors configured to cause the device to perform the method of one or more of Aspects 1-68.

Aspect 71: An apparatus for wireless communication, the apparatus comprising at least one means for performing the method of one or more of Aspects 1-68.

Aspect 72: A non-transitory computer-readable medium storing code for wireless communication, the code comprising instructions executable by one or more processors to perform the method of one or more of Aspects 1-68.

Aspect 73: A non-transitory computer-readable medium storing a set of instructions for wireless communication, the set of instructions comprising one or more instructions that, when executed by one or more processors of a device, cause the device to perform the method of one or more of Aspects 1-68.

Aspect 74: A device for wireless communication, the device comprising a processing system that includes one or more processors and one or more memories coupled with the one or more processors, the processing system configured to cause the device to perform the method of one or more of Aspects 1-68.

Aspect 75: An apparatus for wireless communication at a device, the apparatus comprising one or more memories and one or more processors coupled to the one or more memories, the one or more processors individually or collectively configured to cause the device to perform the method of one or more of Aspects 1-68.

Aspect 76: A device comprising a processing system that includes one or more processors and one or more code-storing memories coupled with the one or more processors, the processing system configured to cause the device to perform the method of one or more of Aspects 1-68.

Aspect 77: A device comprising a processing system that includes processor circuitry and code-storing memory circuitry, the processing system configured to cause the device to perform the method of one or more of Aspects 1-68.

Further disclosure is included in the appendix. The appendix is provided as an example only and is to be considered part of the specification. A definition, illustration, or other description in the appendix does not supersede or override similar information included in the detailed description or figures. Furthermore, a definition, illustration, or other description in the detailed description or figures does not supersede or override similar information included in the appendix. Furthermore, the appendix is not intended to limit the disclosure of possible aspects.

It will be apparent that systems or methods described herein may be implemented in different forms of hardware or a combination of hardware and software. A component being configured to perform a function means that the component has a capability to perform the function, and does not require the function to be actually performed by the component, unless noted otherwise.

As used herein, the term “determine” or “determining” can encompass one or more of a wide variety of actions. For example, “determining” can include one or more of calculating, computing, processing, deriving, detecting, estimating, investigating, looking up, inferring, ascertaining, measuring, resolving, selecting, choosing, obtaining, identifying, interpreting, demodulating, decoding, reading, establishing, forming or generating, among other examples. In some such examples, determining can involve a processor performing some type of calculating, computing, deriving, estimating, inferring, ascertaining, resolving, predicting or other processing to obtain one or more numerical values, sets, elements or other information or results. In some other such examples, determining can involve a processor identifying, looking up, investigating or otherwise obtaining some type of value, set, element or other information or result from a table, a data structure, a database or other memory device or location. In some other such examples, determining can involve a processor identifying, interpreting, demodulating, decoding, detecting, reading or otherwise obtaining some type of value, set, element or other information or result signaled in, for example, a received wireless packet. In some other such examples, determining can involve a processor selecting or choosing one or more values, sets, elements or other information or results from a larger set of values, sets elements or other information or results. In some other such examples, determining can involve a processor performing a measurement, such as on a received signal.

As used herein, the articles “a” and “an” are intended to refer to one or more items and may be used interchangeably with “one or more” or “at least one.” As used herein, a phrase referring to “at least one of” or “one or more of” a list of items refers to any combination of those items, including single members. As an example, “at least one of: a, b, or c” is intended to cover: a, b, c, a-b, a-c, b-c, and a-b-c. Additionally, as used herein, a phrase referring to “a” or “an” element refers to one or more of such elements acting individually or collectively to perform the recited function(s). Additionally, as used herein, a “set” can refer to one or more items, and a “subset” can refer to a whole set or less than the whole set, but not an empty set. “Set,” “group,” and similar terms are intended to include one or more items and may be used interchangeably with “one or more.” Furthermore, as used herein, the term “or” is intended to be interpreted in the inclusive sense (such as when referring to a series) and may be used interchangeably with “and/or,” unless otherwise explicitly indicated (for example, if used in conjunction with “either” or “only one of”). For example, “A or B” may include A only, B only, or a combination of A and B. Also, as used herein, the terms “has,” “have,” “having,” “comprise,” “comprising,” “include” and “including,” and derivatives thereof or similar terms are intended to be open-ended terms that do not limit an element that they modify (for example, an element “having” A also may have B).

As used herein, the phrase “associated with” is intended to be interpreted in the inclusive sense, unless otherwise explicitly indicated. For example, the phrase “associated with” is not to be construed as a reference to a closed set of conditions, factors, criteria, elements, components, or actions, among other examples. Specifically, unless a phrase refers to “associated with only ‘a,’” or the equivalent in context, whatever it is that is “associated with ‘a,’” may be associated with “a” alone or associated with a combination of “a” and one or more other conditions, factors, criteria, elements, components, or actions, among other examples. In various examples, the phrase “associated with” may be interpreted to mean “in association with,” “in accordance with,” “based on,” “based at least in part on,” “as a function of,” “in response to,” “responsive to,” or “using” as appropriate in the relevant context unless otherwise explicitly indicated. Furthermore, what follows the phrase “associated with,” “in association with,” “in accordance with,” “based on,” “based at least in part on,” “as a function of,” “in response to,” “responsive to,” or “using” is not necessarily the focal point or primary factor associated with the limitation preceding the phrase.

As used herein, “satisfying a threshold” may, depending on the context, refer to a value being greater than the threshold, greater than or equal to the threshold, less than the threshold, less than or equal to the threshold, equal to the threshold, or not equal to the threshold, among other examples.

Even though particular combinations of features are recited in the claims or disclosed in the specification, these combinations are not intended to limit the scope of all aspects described herein. Many of these features may be combined in ways not specifically recited in the claims or disclosed in the specification. The disclosure of various aspects includes each dependent claim in combination with every other claim in the claim set.

What is claimed is:

1. A user equipment (UE), comprising:
a processing system that includes one or more processors and one or more code-storing memories coupled with the one or more processors, the processing system configured to cause the UE to:
transmit, to a network node, a first capability indication indicating support for a first group of primary sub-band full duplex (SBFD) operations,
wherein the first group of primary SBFD operations includes two or more of:
transmitting SBFD uplink communications only within uplink sub-bands of SBFD symbols configured in downlink symbols or flexible symbols,
receiving SBFD downlink communications only within downlink sub-bands of SBFD symbols configured in downlink symbols or flexible symbols,
determining a link direction in accordance with one or more configured or scheduled communications and one or more collision handling rules, or
applying a configuration for one or more power control parameters within a unified transmission configuration information state for the SBFD uplink communications in SBFD symbols;
configuring a maximum number of downlink-uplink switches per SBFD slot,
configuring a maximum number of downlink-uplink switches per SBFD or time division duplexing period,
configuring one or more sounding reference signal (SRS) sets, wherein each of the one or more SRS sets is associated with one of SBFD symbols or non-SBFD symbols, or
configuring a contiguous or non-contiguous channel state information reference signal resource that overlaps one or more SBFD sub-band boundaries;
transmit the SBFD uplink communications in accordance with the first group of primary SBFD operations; and
receive the SBFD downlink communications in accordance with the first group of primary SBFD operations.

2. The UE of claim 1, wherein the processing system is configured to cause the UE to transmit, to the network node, a second capability indication indicating support for one or more supplemental SBFD operations.

3. The UE of claim 2, wherein the one or more supplemental SBFD operations includes applying a configuration for one or more partial resource block groups for a physical downlink shared channel or a physical uplink shared channel communications using frequency domain resource allocation type 0.

4. The UE of claim 2, wherein the one or more supplemental SBFD operations includes mapping a demodulation reference signal sequence to one or more assigned physical resource blocks within one or more downlink sub-bands or one or more uplink sub-bands in one or more physical resource blocks.

5. The UE of claim 2, wherein the one or more supplemental SBFD operations includes rate matching a physical downlink shared channel (PDSCH) for one or more frequency domain resource allocation type 1 narrow-band precoding resource block groups,
wherein one or more PDSCH resources are mapped to an assigned physical resource block within a downlink sub-band.

6. The UE of claim 2, wherein the one or more supplemental SBFD operations includes configuring a number of downlink sub-bands for downlink scheduling in SBFD symbols.

7. The UE of claim 2, wherein the one or more supplemental SBFD operations includes configuring a minimum guard band between an uplink sub-band and a downlink sub-band.

8. The UE of claim 2, wherein the one or more supplemental SBFD operations include one or more of an uplink transmission or a downlink reception across different SBFD slots, wherein the uplink transmission or the downlink reception in each slot is configured in SBFD symbols or non-SBFD symbols.

9. The UE of claim 2, wherein the one or more supplemental SBFD operations includes transmitting a partial channel state information sub-band report.

10. The UE of claim 1, wherein the first group of primary SBFD operations includes determining a transport block size in accordance with one or more valid physical resource blocks (PRBs) within one or more downlink sub-bands or within an uplink sub-band and in accordance with a mapping of demodulation reference signals of SBFD symbols to the one or more valid PRBs.

11. The UE of claim 1, wherein the first group of primary SBFD operations includes applying a frequency hopping offset in accordance with a frequency hopping offset list for SBFD uplink physical uplink shared channel (PUSCH) communications in SBFD symbols.

12. The UE of claim 1, wherein the first group of primary SBFD operations includes configuring one or more frequency hopping resources for SBFD uplink physical uplink control channel (PUCCH) communications,
wherein the one or more frequency hopping resources includes one or more of a first frequency hop resource block and a second frequency hop resource block for each physical uplink control channel resource.

13. The UE of claim 1, wherein the first group of primary SBFD operations includes uplink transmission or downlink reception across different slots, wherein each slot is configured with one of only SBFD symbols or only non-SBFD symbols.

14. The UE of claim 1, wherein the first group of primary SBFD operations further includes configuring a maximum number of downlink-uplink switches per SBFD slot.

15. The UE of claim 1, wherein the first group of primary SBFD operations further includes configuring a maximum number of downlink-uplink switches per SBFD or time division duplexing period.

16. The UE of claim 1, wherein the first group of SBFD operations further includes configuring one or more sounding reference signal (SRS) sets, wherein each of the one or more SRS sets is associated with one of SBFD symbols or non-SBFD symbols.

17. The UE of claim 1, wherein the first group of SBFD operations further includes configuring a contiguous channel state information reference signal (CSI-RS) resource that overlaps one or more SBFD sub-band boundaries,
wherein the contiguous CSI-RS resource is associated with a downlink physical resource block.

18. The UE of claim 1, wherein the first group of SBFD operations further includes:
configuring a non-contiguous channel state information (CSI) reference signal (CSI-RS) resource in two or more downlink sub-bands; and
reporting a capability associated with a CSI processing timeline.

19. The UE of claim 1, wherein the processing system is configured to cause the UE to transmit, to the network node, a second capability indication indicating support for a physical random access channel (PRACH) transmission associated with one or more random access channel (RACH) operations, wherein the one or more RACH operations includes a first RACH operation in a first random access occasion in SBFD symbols.

20. The UE of claim 19, wherein the processing system is configured to cause the UE to transmit, to the network node, a third capability indication indicating support of a PRACH transmission in a second random access occasion in SBFD symbols,
wherein the second capability indication indicates support for SBFD random access using a first RACH configuration, and
wherein the third capability indication indicates support for SBFD random access using a second RACH configuration.

21. The UE of claim 1, wherein the processing system is configured to cause the UE to transmit, to the network node, a second capability indication that indicates support for a physical random access channel (PRACH) transmission with preamble repetition in a set of random access occasions.

22. The UE of claim 1, wherein the processing system is configured to cause the UE to transmit, to the network node, a second capability indication that indicates support for a physical random access channel (PRACH) transmission in a random access occasion across SBFD symbols and non-SBFD symbols.

23. The UE of claim 1, wherein the processing system is configured to cause the UE to transmit, to the network node, a second capability indication indicating support for a physical random access channel (PRACH) transmission associated with one or more random access channel (RACH) operations, wherein the one or more RACH operations includes repetition of a physical uplink shared channel (PUSCH) transmission in one or more SBFD symbols.

24. The UE of claim 23, wherein the one or more RACH operations includes one or more of:
repetition of the PUSCH transmission scheduled by a random access response uplink grant and downlink control information format 0_0 with a cyclic redundancy check scrambled by a radio network temporary identifier in the one or more SBFD symbols,
wherein at least two of the one or more SBFD symbols have different power control parameters; or
configuring one or more reference signal received power (RSRP) thresholds for repetitions of PUSCH transmissions in the one or more SBFD symbols,
wherein at least one of the one or more RSRP thresholds for repetitions of PUSCH transmissions in the one or more SBFD symbols is different from at least one of one or more RSRP thresholds for repetitions of PUSCH transmissions in non-SBFD symbols.

25. The UE of claim 23, wherein the PUSCH transmission is a message 3 random access channel communication.

26. The UE of claim 1, wherein the processing system is configured to cause the UE to transmit, to the network node, a second capability indication indicating support for a physical random access channel (PRACH) transmission associated with one or more random access channel (RACH) operations, wherein the one or more RACH operations includes repetition of a physical uplink control channel (PUCCH) transmission in one or more SBFD symbols.

27. The UE of claim 1, wherein the processing system is configured to cause the UE to transmit, to the network node, a second capability indication indicating support for separate physical uplink shared channel (PUSCH) resource element (RE)-level resource muting for a cyclic prefix (CP) orthogonal frequency division multiplexing (OFDM) waveform and a discrete Fourier transform spread OFDM waveform.

28. A method of wireless communication at a user equipment (UE), comprising:
transmitting, to a network node, a first capability indication indicating support for a first group of primary sub-band full duplex (SBFD) operations,
wherein the first group of primary SBFD operations includes two or more of:
transmitting SBFD uplink communications only within uplink sub-bands of SBFD symbols configured in downlink symbols or flexible symbols,
receiving SBFD downlink communications only within downlink sub-bands of SBFD symbols configured in downlink symbols or flexible symbols,
determining a link direction in accordance with one or more configured or scheduled communications and one or more collision handling rules,
applying a configuration for one or more power control parameters within a unified transmission configuration information state for the SBFD uplink communications in SBFD symbols,
configuring a maximum number of downlink-uplink switches per SBFD slot,
configuring a maximum number of downlink-uplink switches per SBFD or time division duplexing period,
configuring one or more sounding reference signal (SRS) sets, wherein each of the one or more SRS sets is associated with one of SBFD symbols or non-SBFD symbols, or
configuring a contiguous or non-contiguous channel state information reference signal resource that overlaps one or more SBFD sub-band boundaries;
transmitting the SBFD uplink communications in accordance with the first group of primary SBFD operations; and
receiving the SBFD downlink communications in accordance with the first group of primary SBFD operations.

29. A non-transitory computer-readable medium storing a set of instructions for wireless communication, the set of instructions comprising:
one or more instructions that, when executed by one or more processors of a user equipment (UE), cause the UE to:
transmit, to a network node, a first capability indication indicating support for a first group of primary sub-band full duplex (SBFD) operations,
wherein the first group of primary SBFD operations includes two or more of:
transmitting SBFD uplink communications only within uplink sub-bands of SBFD symbols configured in downlink symbols or flexible symbols,
receiving SBFD downlink communications only within downlink sub-bands of SBFD symbols configured in downlink symbols or flexible symbols,
determining a link direction in accordance with one or more configured or scheduled communications and one or more collision handling rules,
applying a configuration for one or more power control parameters within a unified transmission configuration information state for the SBFD uplink communications in SBFD symbols,
configuring a maximum number of downlink-uplink switches per SBFD slot,
configuring a maximum number of downlink-uplink switches per SBFD or time division duplexing period,
configuring one or more sounding reference signal (SRS) sets, wherein each of the one or more SRS sets is associated with one of SBFD symbols or non-SBFD symbols, or
configuring a contiguous or non-contiguous channel state information reference signal resource that overlaps one or more SBFD sub-band boundaries;
transmit the SBFD uplink communications in accordance with the first group of primary SBFD operations; and
receive the SBFD downlink communications in accordance with the first group of primary SBFD operations.

30. An apparatus for wireless communication, comprising:
means for transmitting, to a network node, a first capability indication indicating support for a first group of primary sub-band full duplex (SBFD) operations,
wherein the first group of primary SBFD operations includes two or more of:
transmitting SBFD uplink communications only within uplink sub-bands of SBFD symbols configured in downlink symbols or flexible symbols,
receiving SBFD downlink communications only within downlink sub-bands of SBFD symbols configured in downlink symbols or flexible symbols,
determining a link direction in accordance with one or more configured or scheduled communications and one or more collision handling rules,
applying a configuration for one or more power control parameters within a unified transmission configuration information state for the SBFD uplink communications in SBFD symbols,
configuring a maximum number of downlink-uplink switches per SBFD slot,
configuring a maximum number of downlink-uplink switches per SBFD or time division duplexing period,
configuring one or more sounding reference signal (SRS) sets, wherein each of the one or more SRS sets is associated with one of SBFD symbols or non-SBFD symbols, or
configuring a contiguous or non-contiguous channel state information reference signal resource that overlaps one or more SBFD sub-band boundaries;
means for transmitting the SBFD uplink communications in accordance with the first group of primary SBFD operations; and
means for receiving the SBFD downlink communications in accordance with the first group of primary SBFD operations.
